(19) United States
(12) Patent Application Publication
(10) Pub. No.: US 2026/0239140 A1
(43) Pub. Date: Aug. 13, 2026

(54) Layer 1/Layer 2 Triggered Mobility (LTM) Cell Switch Procedure

(71) Applicant: Telefonaktiebolaget LM Ericsson (publ), Stockholm (SE)

(72) Inventors: Pontus Wallentin, Linköping (SE); Stefan Henrik Andreas Wager, Espoo (FI); Antonino Orsino, Kirkkonummi (FI); Icaro Leonardo Da Silva, Solna (SE); Claes Tidestav, Bålsta (SE)

(21) Appl. No.: 19/470,918

(22) PCT Filed: Apr. 4, 2024
(86) PCT No.: PCT/SE2024/050314

§ 371 Date: Sep. 30, 2025

Related U.S. Application Data
(60) Provisional application No. 63/494,495, filed on Apr. 6, 2023.

(51) Int. Cl. H04W 36/08

(52) U.S. Cl. CPC H04W 36/08

(57) ABSTRACT

In an example, a method performed by a User Equipment (UE) for performing a L1/L2-triggered mobility (LTM) cell switch procedure is provided. The method comprises receiving one or more LTM candidate cell configurations, and receiving, from a network node, one or more messages associated with a layer lower than a Radio Resource Control (RRC) layer. The one or more messages identify one of the one or more LTM candidate cell configurations and include one or more parameters for the UE. The method also comprises, in response to receiving the one or more messages, applying the identified LTM candidate cell configuration, and in response to applying the identified LTM candidate cell configuration, applying the one or more parameters.

### TECHNICAL FIELD

Examples of this disclosure relate to a Layer 1/Layer 2-triggered mobility (LTM) cell switch procedure, for example a method in a User Equipment (UE) for performing a LTM cell switch procedure and a method in a network node for causing a UE to perform a LTM cell switch procedure.

### BACKGROUND

### L1/L2 Based Inter-Cell Mobility in Rel-18

In 3GPP Release 18, a work item known as Further NR mobility enhancements has been agreed. This work item includes a technical area entitled L1/L2 based inter-cell mobility. According to the Work Item Description, WID (RP-223520, 3GPP work item description: Further NR mobility enhancements, MediaTek Inc, Apple, 3GPP TSG RAN Meeting #98-e, Electronic Meeting, Dec. 12-16, 2022):

When the UE moves from the coverage area of one cell to another cell, at some point a serving cell change needs to be performed. Currently serving cell change is triggered by L3 measurements and is done by RRC signalling triggered Reconfiguration with Synchronisation for change of PCell and PSCell, as well as release add for SCells when applicable. All cases involve complete L2 (and L1) resets, leading to longer latency, larger overhead and longer interruption time than beam switch mobility. The goal of L1/L2 based inter-cell mobility is to enable a serving cell change via L1/L2 signalling, in order to reduce the latency, overhead and interruption time.

In this work item, according to the WID, the following is included as one objective of the work:
1. To specify mechanism and procedures of L1/L2 based inter-cell mobility for mobility latency reduction:
   Configuration and maintenance for multiple candidate cells to allow fast application of configurations for candidate cells [RAN2, RAN3]
   Dynamic switch mechanism among candidate serving cells (including SpCell and SCell) for the potential applicable scenarios based on L1/L2 signalling [RAN2, RAN1]
   L1 enhancements for inter-cell beam management, including L1 measurement and reporting, and beam indication [RAN1, RAN2]
      Note 1: Early RAN2 involvement is necessary, including the possibility of further clarifying the interaction between this bullet with the previous bullet
   Timing Advance management [RAN1, RAN2]
   CU-DU interface signaling to support L1/L2 mobility, if needed [RAN3]
Note 2: FR2 specific enhancements are not precluded, if any.
Note 3: The procedure of L1/L2 based inter-cell mobility are applicable to the following scenarios:
   Standalone, CA and NR-DC case with serving cell change within one CG
   Intra-DU case and intra-CU inter-DU case (applicable for Standalone and CA: no new RAN interfaces are expected)
   Both intra-frequency and inter-frequency
   Both FR1 and FR2
   Source and target cells may be synchronized or non-synchronized

In 3GPP, discussions have started on solutions for L1/L2 based inter-cell mobility (sometimes also referred to as LTM, L1/L2-triggered mobility or lower layer-triggered mobility). A basic principle with L1/L2-triggered mobility is that the UE is pre-configured, by the network, with an RRC configuration per LTM candidate cell, sometimes also known as a LTM candidate cell configuration. Such a LTM candidate cell configuration may be an RRCReconfiguration message or one or more IEs/fields/parameters such as CellGroupConfig. The UE performs measurements on these LTM candidate cells and transmits corresponding measurement reports to the network. The network then triggers the execution of a LTM cell switch in the UE to one of these LTM candidate cells by transmitting lower layer signaling in a MAC CE, sometimes also referred to as a LTM cell switch command, to the UE, which then connects to the particular LTM candidate cell and switches to an RRC configuration of this LTM candidate cell.

At the 3GPP meetings, there were multiple agreements made on L1/L2-triggered mobility, and among these are the following:

### Agreements at RAN2 #119BIS-E:

RAN2 assumes that both RACH-based (CFRA, CBRA) and RACH-less procedures for L1 L2 mobility switch may be supported. RACH-less if the UE doesn't need to acquire TA during the cell switch. RAN2 understands that the feasibility of RACH-less may depend on RAN1, and expect that RAN1 is working on this.
RAN2 assumes L1/2 mobility trigger information is conveyed in a MAC CE, FFS if the MAC CE or a DCI is used for the actual triggering.
RAN2 assumes the MAC CE for L1/2 mobility trigger contains at least a candidate configuration index.
R2 assumes that at L1L2 cell switch: Whether the UE performs partial or full MAC reset (FFS what partial reset is, e.g. to avoid data loss), re-establish RLC, perform data recovery with PDCP is explicitly controlled by the network. R2 assumes that this can be configured by RRC. FFS if MAC CE indication(s) is/are needed.

### Agreements at Ran2 #120:

The MAC CE agreed to carry LTM related information for cell switch is used for LTM triggering of the cell switch.
UE arrival in the target cell need to be indicated (somehow)

### Agreements at RAN2 #121:

agree to use Model 1: One RRCReconfiguration message for each candidate target configuration RRCReconfiguration to configure target candidate cells
To determine if to reset L2 or not is based on RRC configuration (e.g. set of cells. FFS if separate for RLC, MAC, PDCP).

### Agreements at Ran1 #112:

RAN1 shares the same understanding as RAN2 on agreement:
   The LTM mobility trigger information is conveyed in a MAC CE
The same MAC CE is used for the LTM triggering.
The agreement on scenario 2 (Beam indication together with cell switch command) at RAN1 #111 is further clarified as the following:
   Beam indication for the target cell(s) is conveyed in the MAC CE used for LTM triggering for scenario 2

There currently exist certain challenge(s). For example, many details of the procedures for L1/L2-based inter-cell mobility are still open in 3GPP. This applies also for the details of the so called LTM cell switch procedure. One problem is that it is not yet specified how the UE processes the information provided in the lower layer signaling (e.g. one or several MAC CEs) received to trigger execution of the LTM cell switch procedure. In particular, when the lower layer signaling includes an indication of an LTM candidate cell configuration, which is a configuration to be applied by the RRC layer, the reception of the lower layer signaling would result in RRC layer actions in the UE. However, the lower layer signaling may include also other, dynamic information, such as beam indication(s), that is to be processed and applied on lower layers (e.g. MAC and/or physical layer).

How these actions in the different layers are performed and in which order has not yet been defined. For example, a received beam indication in the lower layer signaling for LTM cell switch is supposed to indicate a beam in a target cell. However, when the UE receives this beam indication it is still using the old configuration in source cell and cannot directly use the received beam indication. There may also be other dynamic information included in the lower layer signaling received to trigger execution of the LTM cell switch procedure that are meant to be applied for either the source or target configuration, such as a TA value meant for target.

When dynamic information is to be used for the target cell, it may not be valid when applied on the configuration the UE has in the source cell. This may cause unpredictable behavior or even failures, causing the UE to trigger RRC connection re-establishment which may lead to data loss. If any dynamic information has already been applied when the UE applies the indicated LTM candidate cell configuration, this already applied dynamic information may be affected or even lost. For example, if the UE performs a MAC reset as part of the indicated LTM candidate cell configuration being applied, any already applied MAC parameters, such as a Timing Advance value received in a Timing Advance command part of the dynamic information, would be lost and the cell switch may fail or be delayed as the UE will not have uplink (UL) synchronization with the target cell.

### SUMMARY

Certain aspects of the disclosure and their embodiments may provide solutions to these or other challenges. For example, in order to address the above challenges, examples of this disclosure include methods for a User Equipment (UE), comprising receiving at least one LTM candidate cell configuration, receiving, from a source network node, lower layer signaling, with a first part, including an indication of an LTM candidate cell configuration and a second part, including dynamic information, executing an LTM cell switch procedure by applying the received indicated LTM candidate cell configuration and applying received dynamic information.

One aspect of the present disclosure provides a method performed by a User Equipment, UE, for performing a Layer 1/Layer 2-triggered mobility, LTM, cell switch procedure. The method comprises receiving one or more LTM candidate cell configurations, and receiving, from a network node, one or more messages associated with a layer lower than a Radio Resource Control, RRC, layer. The one or more messages identify one of the one or more LTM candidate cell configurations and include one or more parameters for the UE. The method also comprises, in response to receiving the one or more messages, applying the identified LTM candidate cell configuration, and in response to applying the identified LTM candidate cell configuration, applying the one or more parameters.

Another aspect of the present disclosure provides a method performed by a network node for causing a User Equipment, UE, to perform a Layer 1/Layer 2-triggered mobility, LTM, cell switch procedure. The method comprises sending, to the UE, one or more LTM candidate cell configurations, and sending, to the UE, one or more messages associated with a layer lower than a Radio Resource Control, RRC, layer. The one or more messages identify one of the one or more LTM candidate cell configurations and include one or more parameters to be applied by the UE.

A further aspect of the present disclosure provides apparatus in a User Equipment, UE, for performing a Layer 1/Layer 2-triggered mobility, LTM, cell switch procedure. The apparatus comprises a processor and a memory. The memory contains instructions executable by the processor such that the apparatus is operable to receive one or more LTM candidate cell configurations; receive, from a network node, one or more messages associated with a layer lower than a Radio Resource Control, RRC, layer, wherein the one or more messages identify one of the one or more LTM candidate cell configurations and include one or more parameters for the UE; in response to receiving the one or more messages, apply the identified LTM candidate cell configuration; and in response to applying the identified LTM candidate cell configuration, apply the one or more parameters.

A still further aspect of the present disclosure provides apparatus in a network node for causing a User Equipment, UE, to perform a Layer 1/Layer 2-triggered mobility, LTM, cell switch procedure. The apparatus comprises a processor and a memory. The memory contains instructions executable by the processor such that the apparatus is operable to send, to the UE, one or more LTM candidate cell configurations, and send, to the UE, one or more messages associated with a layer lower than a Radio Resource Control, RRC, layer, wherein the one or more messages identify one of the one or more LTM candidate cell configurations and include one or more parameters to be applied by the UE.

An additional aspect of the present disclosure provides apparatus in a User Equipment, UE, for performing a Layer 1/Layer 2-triggered mobility, LTM, cell switch procedure. The apparatus is configured to receive one or more LTM candidate cell configurations; receive, from a network node, one or more messages associated with a layer lower than a Radio Resource Control, RRC, layer, wherein the one or more messages identify one of the one or more LTM candidate cell configurations and include one or more parameters for the UE; in response to receiving the one or more messages, apply the identified LTM candidate cell configuration; and in response to applying the identified LTM candidate cell configuration, apply the one or more parameters.

Another aspect of the present disclosure provides apparatus in a network node for causing a User Equipment, UE, to perform a Layer 1/Layer 2-triggered mobility, LTM, cell switch procedure. The apparatus is configured to send, to the UE, one or more LTM candidate cell configurations, and send, to the UE, one or more messages associated with a layer lower than a Radio Resource Control, RRC, layer, wherein the one or more messages identify one of the one or more LTM candidate cell configurations and include one or more parameters to be applied by the UE.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 shows a method performed by a wireless device according to embodiments of the disclosure;

FIG. 2 shows a method performed by a network node according to embodiments of the disclosure;

FIG. 3 illustrates an example system structure including the entities according to examples of this disclosure;

FIG. 4 illustrates a message sequence chart for a method according to examples of this disclosure;

FIGS. 5A and 5B illustrate a message sequence chart for another method according to examples of this disclosure;

FIG. 6 illustrates a flow chart of a method according to examples of this disclosure;

FIG. 7 shows an example of a communication system in accordance with some embodiments;

FIG. 8 shows a UE in accordance with some embodiments;

FIG. 9 shows a network node in accordance with some embodiments;

FIG. 10 is a block diagram of a host in accordance with various aspects described herein;

FIG. 11 is a block diagram illustrating a virtualization environment in which functions implemented by some embodiments may be virtualized;

FIG. 12 shows a communication diagram of a host communicating via a network node with a UE over a partially wireless connection in accordance with some embodiments; and

FIG. 13 shows a network node in accordance with further embodiments.

### ADDITIONAL EXPLANATION

Some of the embodiments contemplated herein will now be described more fully with reference to the accompanying drawings. Embodiments are provided by way of example to convey the scope of the subject matter to those skilled in the art.

As suggested above, examples of this disclosure include methods for a User Equipment (UE), comprising receiving at least one LTM candidate cell configuration, receiving, from a source network node, lower layer signaling, with a first part, including an indication of an LTM candidate cell configuration and a second part, including dynamic information, executing an LTM cell switch procedure by applying the received indicated LTM candidate cell configuration and applying received dynamic information.

In example methods, the UE transmits uplink data or signalling, such as an RRCReconfigurationComplete message, after having applied the LTM candidate cell configuration and dynamic information.

Examples of this disclosure may also include methods for a source network node (such as a source gNB, a source Distributed Unit, DU, or serving network node such as a serving DU), to handle an LTM cell switch procedure for a UE, comprising, transmitting, to the UE, lower layer signaling, containing a first part, including an indication of an LTM candidate cell configuration and a second part, including dynamic information.

Examples of this disclosure may provide a UE executing an LTM cell switch procedure, receiving lower layer signaling with a first part of the lower layer signaling containing at least an indication of an LTM candidate cell configuration, and a second part containing dynamic information, applying the indicated LTM candidate cell configuration, followed by applying the dynamic information, or vice versa.

Certain embodiments may provide one or more of the following technical advantages. For example, examples of this disclosure may enable a UE to perform an LTM cell switch procedure and apply received dynamic information after having applied the indicated LTM candidate cell configuration. This ensures that the dynamic information is applied on the configuration the UE uses in the target cell, and not in the source cell.

Examples of this disclosure may also enable the UE to determine when to transmit uplink data or signalling, such as an RRCReconfigurationComplete message or a random access procedure, using the target cell configuration.

Example embodiments of this disclosure may also have one or more of the following advantages. Example embodiments may enable the network to provide dynamic information at the time of cell switch execution, to complement or override information provided in the candidate configuration at the time of candidate cell configuration. For instance, this can be used to avoid reserving target cell resources, e.g. resources for contention free random access, during the time from candidate cell configuration until cell change execution. The network can for example provide a set of contention free random access resources in the candidate cell configuration and then indicate in the dynamic information in the cell switch command which of the contention free random access resources that is free to use for the UE.

This disclosure refers to the term “L1/L2 based inter-cell mobility” as used in the Work Item Description in 3GPP, though it interchangeably also uses the terms L1/L2 mobility, L1-mobility, L1 based mobility, L1/L2-centric inter-cell mobility, L1/L2 inter-cell mobility L1/L2-Triggered Mobility, Lower-layer triggered Mobility or LTM. The basic principle is that the UE receives a lower layer signaling from the network indicating to the UE a change (or switch or activation) of its serving cell (e.g. change of PCell, from a source to a target PCell), wherein a lower layer signaling is a message/signaling of a lower layer protocol, which sometimes may be referred as a L1/L2 inter-cell mobility execution command or LTM cell switch command. The change of serving cell (e.g. change of PCell) may also lead to a change in Scell(s) for the same cell group e.g. in case the command triggers the UE to change to another cell group configuration of the same type (e.g. another MCG configuration). Before the UE receives the LTM cell switch command, the UE is configured by the network with one or more LTM candidate cell configurations (e.g. reception of an RRC Reconfiguration message, with at least one LTM candidate cell configuration) A LTM candidate cell configuration may include parameters in the IE CellGroupConfig for an LTM candidate cell and/or an embedded RRC Reconfiguration for an LTM candidate cell.

The term LTM cell switch procedure refers to the process of a UE switching (or changing) its cell from a source cell to a target cell (which may be called here an LTM candidate cell or a neighbour cell), using L1/L2-triggered mobility (LTM). In the context of L1/L2-triggered mobility (LTM), an LTM cell switch procedure may sometimes also be known as L1/L2 based inter-cell mobility execution, LTM execution, dynamic switch, LTM switch, (LTM) cell switch, (LTM) serving cell change or (LTM) cell change. In the context of examples of this disclosure, switching to the LTM candidate cell configuration comprises the UE considering that an LTM candidate cell becomes its new special cell (SpCell) e.g. PCell in case of LTM being configured for a Master Cell Group (MCG) and/or PSCell in case of LTM being configured for a Secondary Cell Group (SCG); or, changing its SpCell from the current PCell to an LTM candidate cell.

Even if the term switch or change of cells is used, that may comprise a switch or change of a whole cell group configuration, which includes a change in the SpCell (e.g. change of PCell, or change of PSCell) and a change in SCells of the cell group (e.g. addition, modification and/or release of one or more SCells).

This disclosure refers to a LTM candidate cell, which is a cell the UE is configured with when configured with L1/L2-triggered mobility. That is a cell the UE can move to in a LTM cell switch procedure, upon reception of a LTM cell switch command. Such cells may also be called candidate cell(s), candidates, mobility candidates, non-serving cells, additional cells, target candidate cell, target candidate, etc. A LTM candidate cell is a cell the UE may perform measurements on (e.g. CSI measurements) so that the UE reports these measurements and network may take educated decision on which beam (e.g. TCI state) and/or cell the UE is to be switched to. An LTM candidate cell may be a candidate to be a target PCell or PSCell, or an SCell of a cell group (e.g. MCG SCell or a SCG SCell).

This disclosure refers to at least one LTM candidate cell configuration and that the UE has received at least one LTM candidate cell configuration. This is also sometimes referred to as a configuration of a LTM candidate cell, which may be an RRC configuration, such as encapsulated in an RRC Reconfiguration message, that the UE receives when being configured with L1/L2-Triggered Mobility. A LTM candidate cell configuration comprises the configuration which the UE needs to start to operate accordingly when it performs an LTM cell switch procedure to that LTM candidate cell e.g. upon reception of the LTM cell switch command indicating the UE to perform a LTM cell switch procedure to that LTM candidate cell, which becomes the target cell and the current (new) SpCell, or an SCell in a serving frequency. The LTM candidate cell configuration comprises parameters of a serving cell (or multiple serving cells, such as a cell group), comprising one or more of the groups of parameters, such as an RRCReconfiguration message an IE CellGroupConfig or an IE SpCellConfig (or the IE SCellConfig, in the case of a Secondary Cell). A LTM candidate cell configuration may in one example comprise one or more of: i) the PCell configuration and one or more SCell configuration(s) of a Master Cell Group (MCG); i) the PSCell configuration and one or more SCell configuration(s) of a secondary Cell Group (SCG). The terms (LTM) candidate configuration, LTM configuration, (LTM) candidate target cell configuration, (LTM) target candidate (cell) configuration may be used interchangeably when referring to LTM candidate cell configuration. An LTM candidate cell configuration is associated with an identifier which is used in the signaling when referring to a certain LTM candidate cell configuration, such as when the UE receives the LTM candidate cell configuration and when the UE receives an LTM cell switch command indicating the UE to perform a LTM cell switch procedure to that LTM candidate cell. This identifier is sometimes known as the LTM candidate cell configuration identity or LTM candidate configuration index (or similar).

The actual LTM candidate cell configuration and its exact content and/or structure of this IE and/or embedded message may be called an RRC model for the candidate configuration, or simply RRC model. An LTM candidate cell configuration comprises the configuration which the UE needs to operate accordingly when it performs (executes) L1/L2 based inter-cell mobility execution to a LTM candidate cell, upon reception of the lower layer signaling (MAC CE) indicating a L1/L2 based inter-cell mobility to a LTM candidate cell (which becomes the target cell and the current (new) PCell, or an SCell in a serving frequency), or upon reception of the lower layer signaling (MAC CE) indicating a L1/L2 based inter-cell mobility to a LTM candidate cell configuration indicated with a candidate configuration index (sometimes also denoted candidate configuration ID). The UE may be configured with multiple LTM candidate cell configurations, so a Candidate DU generates and sends to the CU multiple configuration(s). The actual LTM candidate cell configuration the UE receives during the LTM configuration may be a delta signaling to be applied on top of a reference configuration, so that the actual configuration the UE is to use in the candidate cell upon LTM cell switch is the combination of the LTM candidate cell configuration and the reference configuration (e.g. separately signaled by the network to the UE).

The term “beam” may correspond to a spatial direction in which a signal is transmitted (e.g. by a network node) or received (e.g. by the UE), or a spatial filter applied to a signal which is transmitted or received. Thus, transmitting signals different beams could correspond to transmitting signals in different spatial directions. When the text refers to a “beam which is selected” it may refer to a beam index and/or a Reference Signal (RS) index or identifier, such as a Synchronization Signal block (SSB) index, or a CSI-RS resource identifier. Thus, selecting a beam may correspond to selecting an SSB, associated to an SSB index. Or, selecting a beam may correspond to selecting a CSI-RS, associated to a CSI-RS resource identifier.

The term “beam indication” is used in beam management and represents the signaling where the UE obtains a new QCL indication for reception of DL signals, most notably the PDCCH/PDSCH. In the context of LTM, once the new QCL indication takes effect, i.e., after the beam application time, the UE can receive the DL from the new TRP.

This disclosure refers to lower layer signaling. Lower layer signaling may correspond to one or more fields or parameters in a lower layer message, e.g. one or more fields in one or more MAC Control Element(s) (CE). In the context of a LTM cell switch procedure, the lower layer signaling is sometimes known as an LTM cell switch command. The lower layer signaling includes the information needed by the UE to execute the LTM cell switch procedure and is also used to trigger the switch. The lower layer signaling may include an indication of an LTM candidate cell configuration plus some dynamic information needed for the switch, such as a beam indication. In the context of a LTM cell switch procedure, the lower layer signaling may also contain other dynamic information which is sent to be applied as part of the switch but sometimes may not be part of the LTM cell switch procedure, and rather a separate procedure, which is executed in conjunction (e.g. at the same time, just before, or just after) with the LTM cell switch procedure.

This disclosure refers to dynamic information, sometimes also known as state information. Dynamic information may be one or more fields in the lower layer signaling and may correspond to one or more indications of:
Beam indication
SCell activation/deactivation indication(s)
CSI measurement configuration activation/deactivation indication(s)
TCI state(s) indication(s)
Spatial relation indication
RS indication
UL grant
PUCCH Configuration
SCG state
PRACH configuration to be used e.g. PRACH preamble, preamble set, preamble group out of a set in the RRC configuration;
DL BWP ID
UL BWP ID
C-RNTI out of a set
Timer value
Timing advance information
Any dynamic information which may need to be activated
Any information to change state

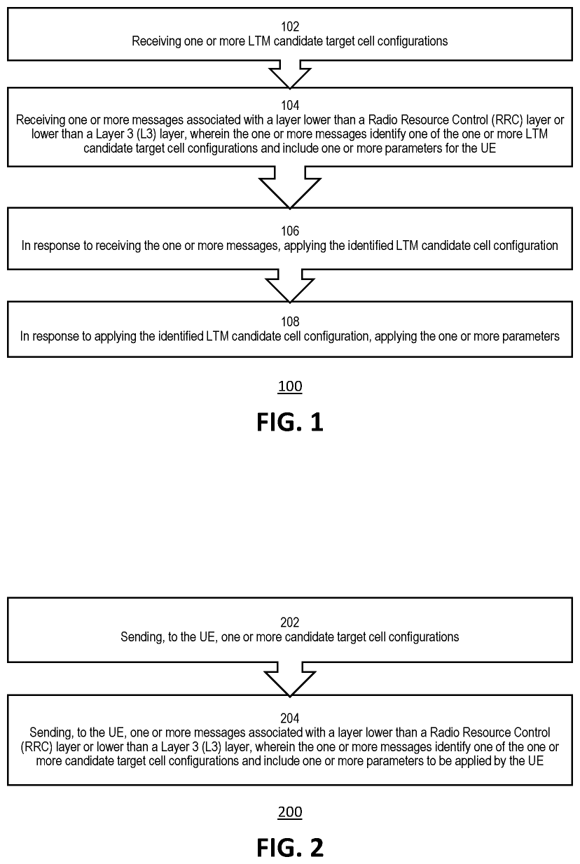

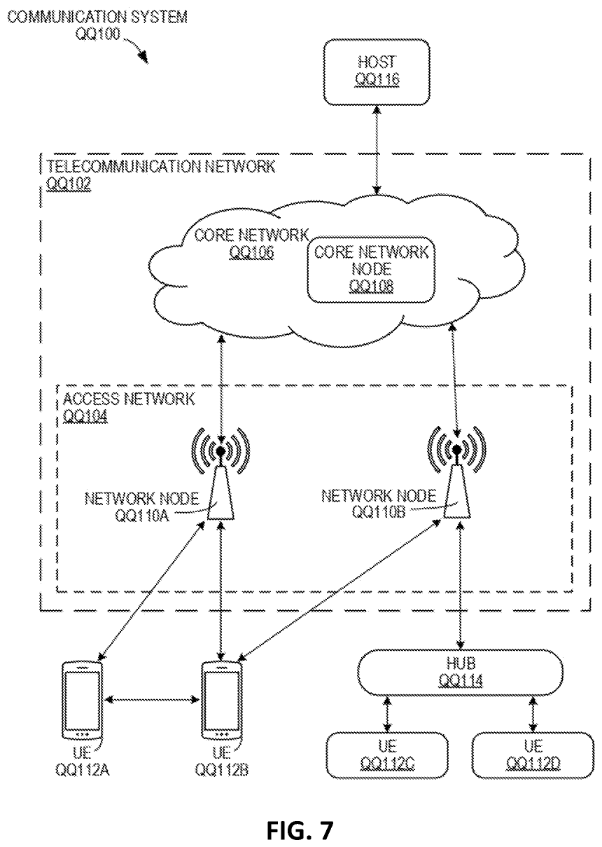

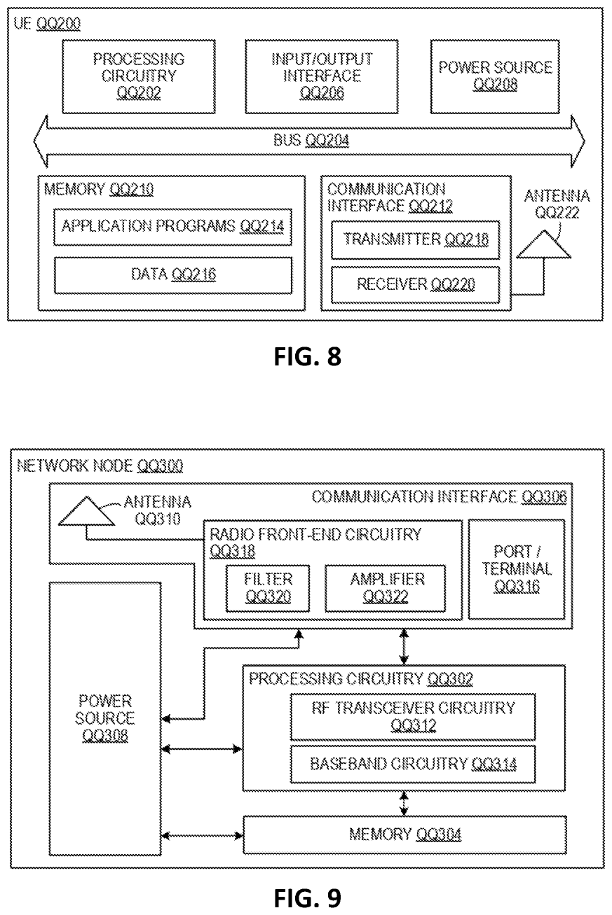

FIG. 1 depicts a method 100 in accordance with particular embodiments, for example a method performed by a User Equipment (UE) for performing a LTM cell switch procedure. The method 100 may be performed by a UE or wireless device (e.g. the UE QQ112 or UE QQ200 as described later with reference to FIGS. 7 and 8 respectively). The method 100 begins at step 102 with receiving one or more LTM candidate target cell configurations. Step 104 of the method 100 comprises receiving, from a network node (e.g. a gNB, Distributed Unit, DU, or Central Unit, CU), one or more messages associated with a layer lower than a Radio Resource Control (RRC) layer, wherein the one or more messages identify one of the one or more LTM candidate cell configurations and include one or more parameters for the UE. Step 106 comprises, in response to receiving the one or more messages, applying the identified LTM candidate cell configuration. Step 108 comprises, in response to applying the identified LTM candidate cell configuration, applying the one or more parameters.

In some examples, performing the cell switch procedure includes applying the identified LTM candidate cell configuration in step 106 of the method 100. That is, for example, the applying of the identified LTM candidate cell configuration is performed as part of the cell switch procedure. In some examples, applying the one or more parameters in step 108 is performed after applying the identified LTM candidate cell configuration. For example, applying the one or more parameters may be performed after applying of the identified LTM candidate cell configuration is complete, or after applying the identified LTM candidate cell configuration has started.

In some examples, the layer lower than the RRC layer comprises a MAC layer, a PDCP layer. a RLC layer, a physical layer, a data link layer, a Layer 1, L1, layer, or a Layer 2, L2, layer. Applying the identified LTM candidate cell configuration is performed by the RRC layer. The RRC layer may for example the identified LTM candidate cell configuration in step 106 in response to an indication from the layer lower than the RRC layer. The indication from the layer lower than the RRC layer may in some examples received after receiving the identification of the identified LTM candidate cell configuration in step 104 of the method 100, and/or the indication identifies the identified LTM candidate cell configuration. The RRC layer may in some examples send an indication to the layer lower than the RRC layer after applying the identified LTM candidate cell configuration in stepo 106.

In some examples, applying the one or more parameters in step 108 of the method 100 is performed by the layer lower than the RRC layer. For example, the one or more parameters may be applied in step 108 by a physical layer or a L1 layer. In such examples, the physical layer or the L1 layer may apply the one or more parameters in step 108 in response to receiving an indication from the RRC layer or a MAC layer, wherein the indication from the RRC layer or the MAC layer indicates that the identified LTM candidate cell configuration has been applied, or the physical layer or the L1 layer app.

Alternatively, applying the one or more parameters in step 108 may in some examples be performed by a MAC layer or L2 layer. The MAC layer or the L2 layer may for example apply the one or more parameters in response to receiving an indication from the RRC layer, wherein the indication from the RRC layer indicates that the identified LTM candidate cell configuration has been applied, or the MAC layer or the L2 layer applies the one or more parameters in response to receiving the one or more parameters.

The one or more messages may comprise one or more MAC control elements (MAC CEs) for example. For example, the one or more parameters and the identification of the identified LTM candidate cell configuration may be received in step 104 of the method 100 in the same MAC CE.

The one or more parameters may comprise one or more of the following non-limiting examples:
a Beam indication;
SCell activation/deactivation indication(s) for one or more SCells of the UE;
CSI measurement configuration activation/deactivation indication(s) for one or more CSI measurement configurations of the UE;
TCI state(s) indication(s);
Spatial relation indication;
RS indication;
UL grant;
PUCCH configuration;
SCG state;
PRACH configuration to be used by the UE;
DL BWP ID;
UL BWP ID;
C-RNTI out of a set;
Timer value for the LTM cell switch procedure; and/or
Timing advance command for the UE.

The identified LTM candidate cell configuration or each of the one or more LTM candidate cell configurations may comprise one or more of the following non-limiting examples:
A cell group configuration for a Master Cell Group, MCG, or a Secondary Cell Group, SCG;
A serving cell configuration for a SpCell, PCell, PSCell or SCell;
A bandwidth Part, BWP, configuration;
An RRCReconfiguration message;
A measurement configuration;
A radio bearer configuration;
A UE identity or C-RNTI;
System information;
A timer configuration;
Another candidate cell configuration;
An indication for the UE to perform a full configuration;
An indication for the UE to perform a delta configuration;
A reference configuration; and/or
Indication(s) whether or not to perform L2 reset, MAC reset, partial MAC reset, full MAC reset, RLC re-establishment and/or PDCP recovery or re-establishment.

The method 100 may in some examples comprise starting a timer in response to applying the identified LTM candidate cell configuration, and stopping the timer in response to any one of the following examples:
successfully performing the LTM cell switch procedure;
successfully applying the identified LTM candidate cell configuration;
successfully performing a random access procedure after applying the identified LTM candidate cell configuration; successful transmission of uplink data or signaling after applying the identified LTM candidate cell configuration;
submission of uplink data or signaling to the layer lower than the RRC layer after applying the identified LTM candidate cell configuration; and/or
reception at the RRC layer of uplink data or signalling to be transmitted after applying the identified LTM candidate cell configuration.

Expiry of the timer may indicate that the cell switch procedure has failed or has not been successfully completed, for example.

The method 100 may also in some examples comprise performing a MAC reset after or as part of applying the identified LTM candidate cell configuration and/or in response to an indication from the RRC layer.

FIG. 2 depicts a method 200 in accordance with particular embodiments, for example a performed by a network node (e.g. a gNB, Distributed Unit, DU, or Central Unit, CU) for causing a User Equipment (UE) to perform a LTM cell switch procedure. The method 200 may be performed by a network node (e.g. the network node QQ110 or network node QQ300 as described later with reference to FIGS. 7 and 9 respectively). The method 200 begins at step 202 with sending, to the UE, one or more LTM candidate target cell configurations. Step 204 of the method 200 comprises sending, to the UE, one or more messages associated with a layer lower than a Radio Resource Control (RRC) layer, wherein the one or more messages identify one of the one or more LTM candidate cell configurations and include one or more parameters to be applied by the UE. The one or more messages may include a command to the UE to perform the cell switch procedure in some examples.

The layer lower than the RRC layer or lower than the L3 layer may be for example a MAC layer, a PDCP layer. a RLC layer, a physical layer, a data link layer, a Layer 1, L1, layer, or a Layer 2, L2, layer.

In some examples, the one or more messages comprise one or more MAC control elements (MAC CEs). The one or more parameters and the identification of the identified LTM candidate cell configuration may in some examples be sent in the same MAC CE.

The one or more parameters may comprise one or more of the following non-limiting examples:
a Beam indication;
SCell activation/deactivation indication(s) for one or more SCells of the UE;
CSI measurement configuration activation/deactivation indication(s) for one or more CSI measurement configurations of the UE;
TCI state(s) indication(s);
Spatial relation indication;
RS indication;
UL grant;
PUCCH configuration;
SCG state;
PRACH configuration to be used by the UE;
DL BWP ID;
UL BWP ID;
C-RNTI out of a set;
Timer value for the LTM cell switch procedure; and/or
Timing advance command for the UE.

The identified LTM candidate cell configuration or each of the one or more LTM candidate cell configurations may comprise one or more of the following non-limiting examples:
A cell group configuration for a Master Cell Group, MCG, or a Secondary Cell Group, SCG;
A serving cell configuration for a SpCell, PCell, PSCell or SCell;
A bandwidth Part, BWP, configuration;
An RRCReconfiguration message;
A measurement configuration;
A radio bearer configuration;
A UE identity or C-RNTI;
System information;
A timer configuration;
Another candidate cell configuration;
An indication for the UE to perform a full configuration;
An indication for the UE to perform a delta configuration;
A reference configuration; and/or
Indication(s) whether or not to perform L2 reset, MAC reset, partial MAC reset, full MAC reset, RLC re-establishment and/or PDCP recovery or re-establishment.

Particular Example Embodiments Will Now Be Described.

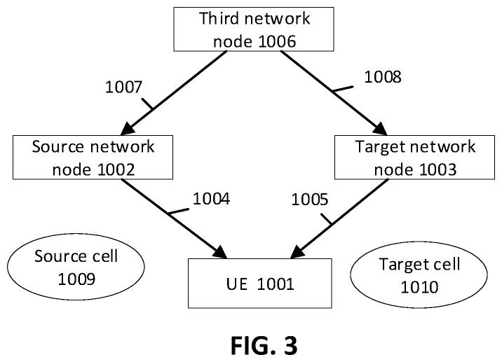

FIG. 3 illustrates an example system structure including the entities according to examples of this disclosure. The User Equipment (UE) 1001 is a wireless terminal, such as a cellular smartphone, sometimes connected to the source network node 1002 over a wireless interface 1004 and sometimes connected to a target network node 1003, to which the UE 1001 is connected over a wireless interface 1005.

In the context of a mobility procedure, such as a LTM cell switch procedure, for the UE, the source network node 1002, sometimes also referred to as the serving network node, controls a source cell 1009 (sometimes called serving cell or Special Cell (SpCell). The target network node 1003 controls a target cell 1010 (sometimes called neighbour cell, candidate cell or LTM candidate cell). Each of source network node 1002 and the target network node 1003 may be a base station such as e.g. gNB, or, e.g. in case of a distributed CU/DU RAN architecture, a distributed unit, sometimes known as either gNB-DU or DU. Hence the source network node 1002 corresponds to a source DU, S-DU, sometimes also known as serving DU, and the target network node 1003 corresponds to a target DU. T-DU (sometimes called neighbour DU or candidate DU, C-DU). Both the source network node 1002 and the target network node 1003 are connected to a third network node 1006, sometime also referred to as serving network node. The source network node and the target network node may be the same network node. In some scenarios the source network node 1002 and the target network node 1003 may be connected to different third network nodes 1006.

Further, the third network node 1006 may, e.g. in case of a distributed CU/DU RAN architecture, be a central unit, CU, sometimes referred to as the serving CU, known as either a gNB-CU, CU, gNB-CU-CP or gNB-CU-UP, or a core network node such as an User Plane Function, UPF or an Access and Mobility management Function, AMF.

In an examples, a Method for a User Equipment, UE, to execute an LTM cell switch procedure is provided, comprising receiving at least one LTM candidate cell configuration, receiving, from a source network node, lower layer signaling, containing a first part, including an indication of an LTM candidate cell configuration and a second part, including dynamic information, executing an LTM cell switch procedure by applying the received indicated LTM candidate cell configuration and applying received dynamic information. The UE may in some examples apply the indicated LTM candidate cell configuration after having received the first part of the lower layer signaling. The UE may in some examples apply the dynamic information after having received the second part of the lower layer signaling. The UE may in some examples apply the dynamic information after having applied the indicated LTM candidate cell configuration. The received dynamic information may in some examples be applied on top of the applied indicated LTM candidate cell configuration. The lower layer signaling may in some examples include an LTM cell switch command. The indicated LTM candidate cell configuration may in some examples be included in the LTM cell switch command. The method, wherein the first part of the lower layer signaling may in some examples include an LTM cell switch command. The UE may in some examples apply the dynamic information after having applied the LTM cell switch command. The dynamic information may in some examples be associated with the indicated LTM candidate cell configuration. The dynamic information may in some examples be associated with the LTM cell switch command. The UE may in some examples transmit uplink data or signaling according to the applied LTM candidate cell configuration. The UE may in some examples transmit uplink data or signaling according to the applied dynamic information. The UE may in some examples transmit uplink data or signaling after having applied the LTM candidate cell configuration or the dynamic information. The UE may in some examples transmit uplink data or signaling after having applied both the LTM candidate cell configuration and the dynamic information. The UE may in some examples perform a random access procedure. The transmitted uplink data or signaling may in some examples be an RRCReconfigurationComplete message. The RRC layer in the UE may in some examples submit the RRCReconfigurationComplete message for transmission as response to having received an indication from the lower layers. The indication from the lower layers may in some examples indicate that a dynamic information has been applied. The lower layers may in some examples be one or more of: the RRC layer applies the indicated LTM candidate cell configuration. The RRC layer may in some examples apply the indicated LTM candidate cell configuration as response to receiving an indication from the lower layers. The indication from the lower layers may in some examples be received after the lower layers has received the first part of the lower layer signaling. The indication from the lower layers may in some examples include an indication of an LTM candidate cell configuration. The indication of an LTM candidate cell configuration may in some examples be a candidate configuration ID. The lower layers may in some examples be one or more of: the MAC layer, the PDCP layer, the RLC layer, and/or the physical layer. The RRC layer may in some examples transmit an indication to the lower layers as response to applying the indicated LTM candidate cell configuration. The lower layers in the UE may in some examples apply the dynamic information. The physical layer may in some examples apply a dynamic information as response to receiving an indication from the MAC layer. The physical layer may in some examples apply a dynamic information as response to receiving an indication from the RRC layer. The indication from the RRC layer may in some examples indicate that the LTM candidate cell configuration has been applied. The indication of an LTM candidate cell configuration may in some examples be a candidate configuration ID. The physical layer may in some examples apply a dynamic information as response to having received the second part of the lower layer signaling. The physical layer may in some examples apply a second dynamic information as indicated by the RRC layer. In one example the physical layer may still process the lower layer signaling but instead of considering the dynamic information within the second part of the lower layer signaling, the physical layer will consider the second dynamic information provided by the RRC layer. The MAC layer may in some examples apply a dynamic information as response to receiving an indication from the RRC layer. The indication from the RRC layer may in some examples indicate that the LTM candidate cell configuration has been applied. In one example, the indication of an LTM candidate cell configuration is a candidate configuration ID. The MAC layer may in some examples apply a dynamic information as response to having received the second part of the lower layer signaling. The MAC layer may in some examples apply a second dynamic information as indicated by the RRC layer. In one example the MAC layer may still process the lower layer signaling but instead of considering the dynamic information within the second part of the lower layer signaling, the MAC layer will consider the second dynamic information provided by the RRC layer. The first and second part of the lower layer signaling may in some examples both be included in the same MAC CE. The first part of the lower layer signaling may in some examples be included in a first MAC CE and the second part of the lower layer signaling is included in a second MAC CE. The first and second part of the lower layer signaling may in some examples be concatenated and/or multiplexed in the same MAC Protocol Data Unit. Thus, the UE first processes the first MAC CE and determines that this is a first part of the lower layer signaling for a given LTM candidate cell configuration, applies that indicated LTM candidate cell configuration, and then processes the second MAC CE, which is associated to the LTM candidate cell configuration e.g. dynamic information and/or activation of parameters within the LTM candidate cell configuration.

In some examples, the first part of the lower layer signaling comprises a first MAC CE and the second part of the lower layer signaling comprises multiple MAC CE(s), wherein the first and the other MAC CE(s) are concatenated and/or multiplexed in the same MAC Protocol Data Unit. Thus, the UE first processes the first MAC CE and determines that this is a first part of the lower layer signaling for a given LTM candidate cell configuration, applies that indicated LTM candidate cell configuration, and then processes the remaining MAC CE(s), which is associated to the LTM candidate cell configuration, e.g. dynamic information and/or activation of parameters within the LTM candidate cell configuration. In some examples, the second part of the lower layer signaling comprises multiple IDs each one of them referring to a certain MAC CE. This basically indicate to the UE that when a MAC CE that comprises a certain ID is received, the UE may apply the second part of the lower layer signaling as far as the ID received in the MAC CE is listed among the IDs included in the second part of the lower layer signaling. In some examples, the first part of the lower layer signaling comprises multiple IDs each one of them referring to a certain second part of the lower layer signaling. For example, this basically indicate to the UE that when a MAC CE that comprises a certain ID is received, the configuration that is inside that MAC CE can be applied to one or more dynamic information. This means that the network may only provide only the dynamic information if it does not want to change the configuration received in a previous MAC CE. The lower layer signaling may in some examples include an indication whether it includes the second part of the lower layer signaling or not. There may in some examples be a first part of the lower layer signaling with an identifier which indicates to the UE that it includes a second part of the lower layer signaling, and another identifier which indicates to the UE that the lower layer signaling does not include a second part of the lower layer signaling. In one example, the identifier may correspond to a logical channel ID (or logical channel group ID). The lower layer signaling may in some examples include an indication whether it includes dynamic information or not. There may in some examples be a lower layer signaling with an identifier which indicates to the UE that it includes a dynamic information, and another identifier which indicates to the UE that the lower layer signaling does not include a dynamic information. The identifier may in some examples correspond to a logical channel ID (or logical channel group ID). The received dynamic information may in some examples include at least one of:
SCell activation/deactivation indication(s)
   For example, for a given SCell a value set to ‘0’ indicates that the SCell state is to be set to deactivated or inactivated, while a value set to ‘1’ indicates that the SCell state is to be set to activated
   The indication(s) may correspond to a number of C-fields, wherein for each C, if there is an SCell configured for the MAC entity with SCellIndex i (in the LTM candidate cell configuration indicated in the LTM cell switch command), this field indicates the activation/deactivation status of the SCell with SCellIndex i, else the MAC entity ignores the Ci field. The Ci field is set to 1 to indicate that the SCell with SCellIndex i is to be activated. The Ci field is set to 0 to indicate that the SCell with SCellIndex i shall be deactivated;
   When the UE applies the SCell activation/deactivation indication(s) (after it applied the LTM candidate cell configuration) and an SCell configured in the same cell group as the LTM candidate cell (which is an SpCell) is being activated, the UE applies normal SCell operation including; Sounding Reference Signal (SRS) transmissions on the SCell; Channel State Information (CSI) reporting for the SCell; Physical Downlink Control Channel (PDCCH) monitoring on the SCell; PDCCH monitoring for the SCell; PUCCH transmissions on the SCell, if configured.
      In one scenario, an SCell which is being activated was already an activated SCell in the source cell, before the reception of the LTM cell switch command.
      In another scenario, an SCell which is being activated was also a configured SCell in the same cell group as the source cell, before the reception of the LTM cell switch command, but it was deactivated.
      In another scenario, an SCell which is being activated was not a configured SCell in the same cell group as the source cell.
   When the UE applies the SCell activation/deactivation indication(s) (after it applied the LTM candidate cell configuration) and an SCell configured in the same cell group as the LTM candidate cell (which is an SpCell) is being deactivated, the UE deactivates the SCell according to the timing requirements; the sCellDeactivation Timer associated with the SCell; stops the bwp-Inactivity Timer associated with the SCell; deactivate any active BWP associated with the SCell; clear any configured downlink assignment and any configured uplink grant Type 2 associated with the SCell respectively; clear any PUSCH resource for semi-persistent CSI reporting associated with the SCell; suspend any configured uplink grant Type 1 associated with the SCell; flush all HARQ buffers associated with the SCell; cancel, if any, triggered consistent LBT failure for the SCell; not transmit SRS on the SCell; not report CSI for the SCell; not transmit on UL-SCH on the SCell; not transmit on RACH on the SCell; not monitor the PDCCH on the SCell; not monitor the PDCCH for the SCell; not transmit PUCCH on the SCell.
      In one scenario, an SCell which is being deactivated was already a deactivated SCell in the source cell, before the reception of the LTM cell switch command.
      In another scenario, an SCell which is being deactivated was also a configured SCell in the same cell group as the source cell, before the reception of the LTM cell switch command, but it was an activated.
      In another scenario, an SCell which is being activated was not a configured SCell in the same cell group as the source cell.
CSI measurement configuration activation/deactivation indication(s)
   In one option, the beam indication indicates one or more CSI resources to be considered activated, so that the UE performs one or more CSI measurements on the activated CSI resources e.g. SSBs and/or CSI-RSs, for reporting.
   The CSI measurement configuration activation/deactivation may be associated to one or more of:
      Activation/Deactivation of Semi-persistent CSI-RS/CSI-IM resource set (5.18.2)
      Aperiodic CSI Trigger State Subselection (5.18.3) Activation/Deactivation of Semi-persistent CSI reporting on PUCCH (5.18.6)
      Activation/Deactivation of semi-persistent ZP CSI-RS resource set (5.18.
TCI state(s) indication(s)
   In one option the indication(s) comprises at least one Unified TCI States Activation/Deactivation indication(s) (5.18.23)
      In set of embodiments, the TCI state(s) indication(s) may activate and deactivate the configured unified TCI states of the LTM candidate cell indicated in the LTM cell switch command (e.g. by a configuration or candidate ID), wherein that LTM candidate cell becomes a Serving Cell (e.g. PCell, SpCell) in response to the UE having received the LTM cell switch command (e.g. MAC CE including an indication of the LTM candidate cell configuration and the beam indication). In one sub-option, these configured unified TCI states of the indicated LTM candidate cell are initially deactivated upon (re-)configuration by upper layers i.e. when the UE applies the LTM candidate cell configuration (e.g. RRCReconfiguration, possibly generated by the UE using a reference configuration) in response to the LTM cell switch command.
      Thus, it is only after the UE applies the LTM candidate cell configuration that the UE applies the Unified TCI state Activation/ deactivation indication(s).
      For example, the MAC entity receives the LTM cell switch command (e.g. a MAC CE) including an LTM candidate cell configuration identifier, indicates that to the upper layers and: when the MAC entity (at the UE), receives an indication from upper layers that the LTM candidate cell configuration has been applied, the UE applies the indication of the Unified TCI States Activation/Deactivation on the new Serving Cell (i.e. in the LTM candidate cell which became the new Serving cell); then, the MAC entity at the UE indicate to lower layers the information regarding the Unified TCI States Activation/Deactivation.
      In one set of embodiments, related to the previous (i.e. possibly combined), the Unified TCI States Activation/Deactivation indication(s) comprises one or more of:
         Serving Cell ID: This field indicates the identity of the Serving Cell for which the indication(s) applies, wherein that is a serving cell ID for a serving cell associated with the LTM candidate cell indicated in LTM cell switch command.
         For example, when the UE is configured with an LTM candidate cell A (whose LTM candidate ID is set to “X”) and LTM candidate cell B (whose LTM candidate ID is set to “Y”) and the LTM cell switch command includes the ID set to “X”, the Serving cell ID refers to a serving cell in the same cell group in which the LTM candidate cell A is configured.
         In one option, when that is set to “0” it indicates to the UE that the Unified TCI States Activation/Deactivation indication(s) is to be applied for the SpCell (e.g. PCell), i.e., the actual LTM candidate cell indicated in the LTM cell switch command.
         In one option, when the indicated Serving Cell is configured as part of a simultaneousU-TCI-UpdateList1, simultaneousU-TCI-UpdateList2, simultaneousU-TCI-UpdateList3 or simultaneousU-TCI-UpdateList4, the indication(s) apply to all the Serving Cells in the set simultaneousU-TCI-UpdateList1, simultaneousU-TCI-UpdateList2, simultaneousU-TCI-UpdateList3 or simultaneousU-TCI-UpdateList4, respectively.
         In one option, that indicates to the UE that the Unified TCI States Activation/Deactivation indication(s) is to be applied for an SCell in the same cell group as the LTM candidate cell indicated in the LTM cell switch command.
         DL BWP ID: This field indicates a DL BWP for which the indications(s) apply e.g. as the codepoint of the Downlink Control Information (DCI) bandwidth part indicator field. This is used by the UE to identify which DL BWP to consider when activating a TCI state, configured in a BWP.
         UL BWP ID: This field indicates a UL BWP for which the indication(s) apply e.g. as the codepoint of the DCI bandwidth part indicator field. In one option, when the value of unifiedTCI-State Type in the Serving Cell indicated by Serving Cell ID is joint, this field is considered as the reserved bits.
         Pi: This field indicates whether each TCI codepoint has multiple TCI states or single TCI state. If Pi field is set to 1, it indicates that the i-th TCI codepoint includes the DL TCI state and the UL TCI state. If Pi field is set to 0, it indicates that with TCI codepoint includes only the DL/joint TCI state or the UL TCI state. The codepoint to which a TCI state is mapped is determined by its ordinal position among all the TCI state ID fields.
         D/U: This field indicate whether the TCI state ID in the same octet is for joint/downlink or uplink TCI state. If this field is set to 1, the TCI state ID in the same octet is for joint/downlink. If this field is set to 0, the TCI state ID in the same octet is for uplink.
         TCI state ID: This field indicates the TCI state identified by TCI-StateId in the LTM candidate cell configuration indicated in the LTM cell switch command.
         In one option, when D/U is set to 1, 7-bits length TCI state ID i.e. TCI-StateId is used; and, when D/U is set to 0, the most significant bit of TCI state ID is considered as the reserved bit and remainder 6 bits indicate the UL-TCIState-Id.
   In one option the indication(s) comprises multiple Unified TCI States Activation/Deactivation indication(s), each associated to at least one serving cell (e.g. SCell) in the same cell group as the LTM candidate cell.
   In one option the indication(s) comprises at least one Activation/Deactivation of UE-specific PDSCH TCI state
      In a set of embodiments, the TCI state(s) indication(s) may activate and deactivate the configured TCI states for PDSCH of the LTM candidate cell indicated in the LTM cells with command (e.g. by a configuration or candidate ID), wherein that LTM candidate cell becomes a Serving Cell (e.g. PCell, SpCell) in response to the UE having received the LTM cell switch command (e.g. MAC CE including an indication of the LTM candidate cell configuration and the beam indication). In one sub-option, these configured TCI states for Physical Downlink Shared Channel (PDSCH) of the indicated LTM candidate cell are initially deactivated upon (re-)configuration by upper layers i.e. when the UE applies the LTM candidate cell configuration (e.g. RRCReconfiguration, possibly generated by the UE using a reference configuration) in response to the LTM cell switch command.
      Thus, it is only after the UE applies the LTM candidate cell configuration that the UE applies the TCI state Activation/deactivation for PDSCH indication(s).
      For example, the MAC entity receives the LTM cell switch command (e.g. a MAC CE) including an LTM candidate cell configuration identifier, indicates that to the upper layers and: when the MAC entity (at the UE), receives an indication from upper layers that the LTM candidate cell configuration has been applied, the UE applies the indication of the TCI States Activation/Deactivation for UE-specific PDSCH indication on the new Serving Cell (i.e. in the LTM candidate cell which became the new Serving cell); then, the MAC entity at the UE indicate to lower layers the information regarding the TCI States Activation/Deactivation for UE-specific PDSCH.
      In one set of embodiments, related to the previous (i.e. possibly combined), the TCI States Activation/Deactivation for UE-specific PDSCH indication(s) comprises one or more of:
         Dsds
   In one option the indication of TCI state for UE-specific PDCCH (5.18.5)
DL BWP ID:
   In one option, the indication comprises a DL BWP, which triggers the UE to change the DL BWP.
UL BWP ID:
   In one option, the indication comprises a UL BWP, which triggers the UE to change the UL BWP.
Spatial relation indication, e.g.:
   Activation/Deactivation of Semi-persistent SRS and Indication of spatial relation of SP/AP SRS (5.18.7)
   Activation/Deactivation of spatial relation of PUCCH resource (5.18.8)
UL Timing Advance command
   This controls the amount of timing adjustment in the target cell. The format may be the same as Timing Advance Command in TS 38.321.
RS indication
   Like the TCI state
UL grant
PUCCH configuration
SCG activation/deactivation indication
PRACH configuration to be used e.g. PRACH preamble, preamble set, preamble group out of a set in the RRC configuration;
C-RNTI
   This may be an index pointing to a specific C-RNTI out of a preconfigured C-RNTI set.
Supervision timer value.
   This indicates the starting value for the supervision timer monitoring successful execution of the LTM cell switch
Any dynamic information which may need to be activated
Use of current common parameter (e.g., configuration in ServingCellCommon within the RRCReconfiguration message).
L2 reset indication, e.g. indicating whether full or partial reset is performed.

The indicated LTM candidate cell configuration may in some examples contain at least one of:
A cell group configuration, for a Master Cell Group (MCG) or a Secondary Cell Group (SCG) including a set of cells such as SpCell, PCell, PSCell or SCell(s)
A serving cell configuration, for SpCell, PCell, PSCell or SCell
A bandwidth Part (BWP) configuration
An RRCReconfiguration message
A measurement configuration
A radio bearer configuration
A UE identity, such as a C-RNTI
System information, such as dedicated system information
Timer configuration, including timer values
Another LTM candidate cell configuration
An indication to perform a full configuration
An indication to perform a delta configuration
A reference configuration
Indication(s) whether or not to perform L2 reset, including MAC reset, partial MAC reset, full MAC reset, RLC re-establishment and/or PDCP recovery/re-establishment.

The UE may in some examples start a supervision timer as response to one of:
Reception of the first or second part of the lower layer signaling
Applying the first or second part of the lower layer signaling
Reception of a LTM cell switch command
Applying an LTM candidate cell configuration
Applying a LTM cell switch command
Reception of an indication from the lower layers to the RRC layer
Reception of an indication from the RRC layer to the lower layers
Applying of the dynamic information.

The UE may in some examples stop a supervision timer as response to one of:
Successfully or unsuccessfully applying the first or second part of the lower layer signaling
Successfully or unsuccessfully applying dynamic information
Successfully or unsuccessfully applying an LTM candidate cell configuration
Successfully or unsuccessfully applying an LTM cell switch command
Successful or unsuccessful random access procedure
Successful or unsuccessful transmission of uplink data or signaling
Reception of an indication from the lower layers to the RRC layer
Reception of an indication from the RRC layer to the lower layers
Submission of uplink data or signaling to the lower layers
Reception from higher layer, such as the RRC layer of uplink data or signalling to be transmitted

The supervision timer may in some examples be an RRC timer or a lower layer timer, such as a MAC timer. The UE may in some examples perform L2 reset, such as MAC reset, partial MAC reset, full MAC reset, RLC re-establishment and/or PDCP recovery/re-27 establishment. The UE may in some examples perform L2 reset as response to applying the indicated LTM candidate cell configuration. The UE may in some examples perform L2 reset before the lower layers applies dynamic information. The RRC layer may in some examples determine whether to perform L2 reset. The RRC layer may in some examples indicate to lower layers to perform L2 reset. In one example, the RRC layer indicates to lower layers to perform L2 reset as response to applying the indicated LTM candidate cell configuration. In one example, the RRC layer indicates to lower layers to perform L2 reset before the lower layers applies a dynamic information.

In some examples, methods are provided for a source network node, such as a source gNB, a source DU or a source CU, to handle an LTM cell switch procedure for a UE, comprising, transmitting, to the UE, lower layer signaling, containing a first part, including an indication of an LTM candidate cell configuration and a second part, including dynamic information. The lower layer signaling may in some examples include an LTM cell switch command. The indicated LTM candidate cell configuration may in some examples be included in the LTM cell switch command.

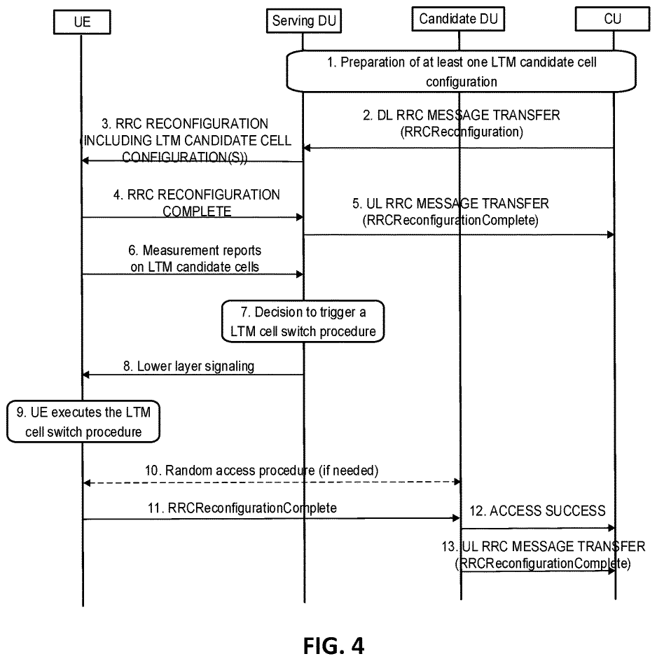

FIG. 4 illustrates a message sequence chart for a method according to examples of this disclosure. The sequence chart shows the following steps of the example method.
Step 1. The network prepares at least one LTM candidate cell configuration. In this example, a candidate cell controlled by the Candidate CU is included in one LTM candidate cell configuration.
Step 2. The CU transmits, to the Serving DU, an DL RRC MESSAGE TRANSFER including an RRCReconfiguration message, which includes the at least one LTM candidate cell configuration.
Step 3. The Serving DU, transmits, the UE, the RRCReconfiguration message, containing the at least one LTM candidate cell configuration.
Step 4. The UE stores the received LTM candidate cell configuration and responds with an RRCReconfigurationComplete message to the Serving DU.
Step 5. The Serving DU transmits, to the CU, an UL RRC MESSAGE TRANSFER containing the received RRCReconfigurationComplete message.
Step 6. The UE measures on the configured LTM candidate cells and transits measurement reports, such lower-layer measurement reports, such as CSI measurements, to the Serving DU.
Step 7. The Serving DU decides to trigger an LTM cell switch procedure to a candidate cell, in this example, a candidate cell controlled by the Candidate DU.
Step 8. The Serving DU transmits lower layer signaling to the UE to trigger the LTM cell switch. The lower layer signaling contains an indication of the LTM candidate cell configuration for the LTM candidate cell and dynamic information.
Step 9. As response to the received lower layer signaling, the UE executes the LTM cell switch procedure. In this example, the UE first applies the indicated LTM candidate cell configuration, then applies the received dynamic information.
Steps 10-11. The UE transmits uplink data or signalling, to the Candidate DU, such as an RRCReconfigurationComplete message, after a potential random access procedure, according to the applied LTM candidate cell configuration and dynamic information.
Steps 12-13. As response to having received the uplink data or signalling from the UE, the Candidate DU transmits, to the CU, an ACCESS SUCCESS indicating the UE arrival in the candidate cell. The CU also forwards, to the CU, the received RRCReconfigurationComplete message carried in an UL RRC MESSAGE TRANSFER message.

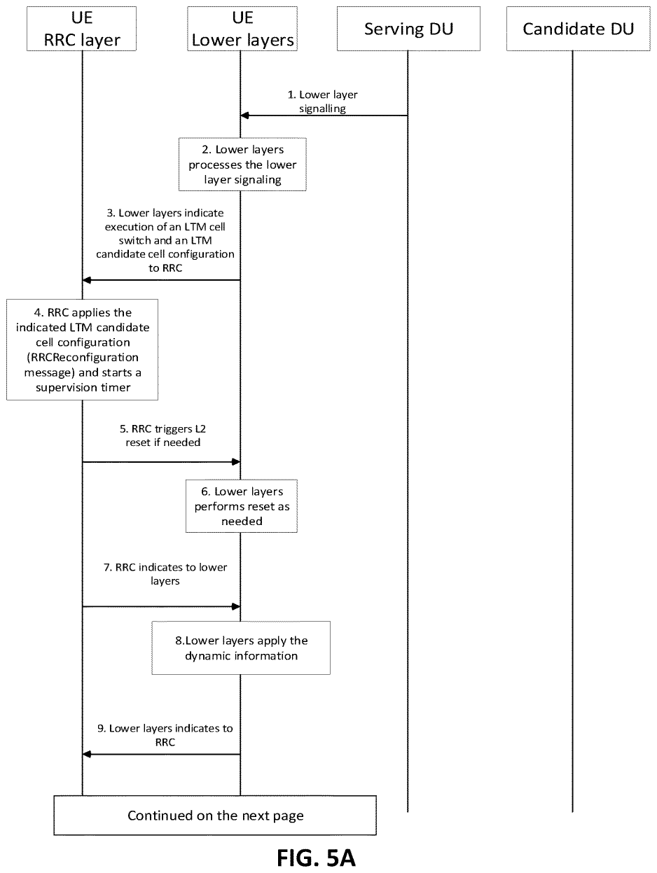

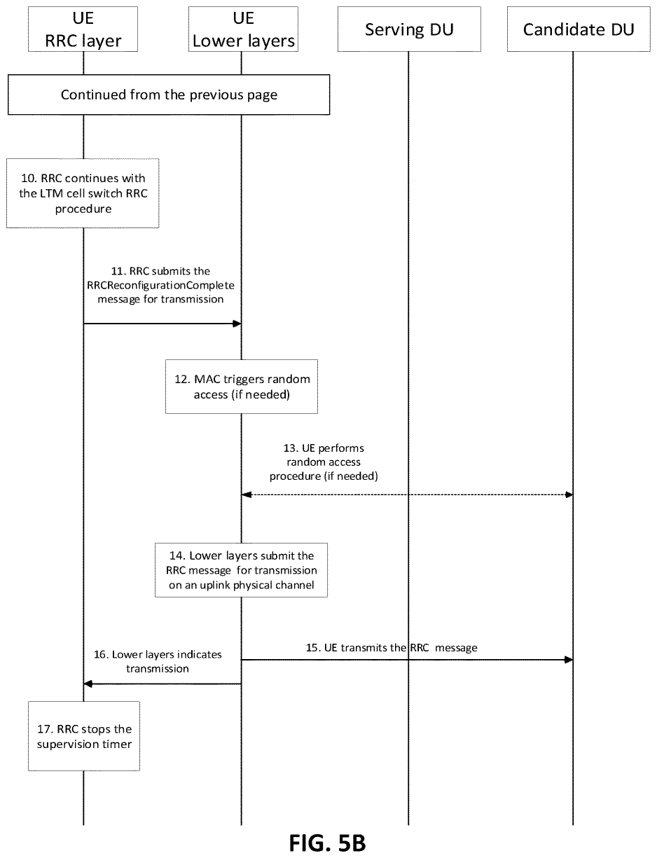

FIGS. 5A and 5B illustrate a message sequence chart for another method according to examples of this disclosure. In this example, the UE is already configured with at least one LTM candidate cell configuration and executes an LTM cell switch procedure. In this example, the UE lower layers represent a layer, or a set of layers, below the RRC layer, such as the MAC layer, the PHY (physical) layer, the RLC layer and/or the PDCP layer. The sequence chart shows the following steps of the example method.
Step 1. The UE receives lower layer signaling (such as one or multiple MAC CEs) to trigger an LTM cell switch procedure. The lower layer signaling, which may be split into parts, such as a first part and a second part, contains an indication of the LTM candidate cell configuration for the LTM candidate cell and dynamic information. In this example, the dynamic information is included in the same part (e.g. same MAC CE) as the indication of the LTM candidate cell configuration. In another example, the indication of the LTM candidate cell configuration is contained in one part (e.g. one MAC CE) and the dynamic information is contained in one or multiple other parts (e.g. other MAC CEs).
Step 2. The UE lower layers (e.g. the UE MAC layer) processes the received lower layer signaling and finds an indication of an LTM candidate cell configuration. This indication is sometimes also known as an LTM candidate configuration index/identity.
Step 3. The UE lower layers (e.g. the UE MAC layer) indicates, to the RRC layer in the UE that an LTM cell switch procedure is executed and forwards the indication of an LTM candidate cell configuration.
Step 4. The RRC layer processes and applies the LTM candidate cell configuration received previously, as indicated by the received indication from the lower layers. In this example, RRC also starts a supervision timer, such as a T304 timer.
Step 5. The RRC layer determines whether or not to perform L2 reset, including MAC reset, partial MAC reset, full MAC reset, RLC re-establishment and/or PDCP recovery/re-establishment. If RRC determines to perform MAC reset or partial MAC reset, the RRC layer indicates to MAC to perform the reset. If RRC determines to perform RLC re-establishment, it indicates to RLC layer to perform RLC re-establishment. If the RRC layer determines to perform PDCP recovery or PDCP re-establishment, it indicates to PDCP layer to perform PDCP recovery or PDCP re-establishment.
Step 6. The lower layers perform the L2 reset actions (including MAC reset, partial MAC reset, full MAC reset, RLC re-establishment and/or PDCP recovery/re-establishment) based on the received indication from RRC. During the (partial) MAC reset, the MAC layer may clear configurations, stop MAC procedures, reset counts, clear buffers stop timers, HARQ reset etc.
Step 7. The RRC layer may continue with the LTM cell switch procedure, for instance, it may configure the lower layers with parameters, e.g. parameters included in the LTM candidate cell configuration. The RRC layer indicates to lower layers that the LTM candidate cell configuration has been applied and this also indicates to continue to apply the lower layer signaling and also the received dynamic information, as the LTM candidate cell configuration has now been applied.
Step 8. As response to receiving the indication from RRC, the lower layers can now continue to apply the lower layer signaling and also the received dynamic information. Examples of received dynamic information that may be applied are:
   SCell activation/deactivation indication(s)
   CSI measurement configuration activation/deactivation indication(s)
   TCI state(s) indication(s)
   UL Timing Advance Command
   Spatial relation indication
   RS indication
   UL grant
   PUCCH configuration
   SCG state
   PRACH configuration to be used e.g. PRACH preamble, preamble set, preamble group out of a set in the RRC configuration;
   C-RNTI
   Timer value
   Any dynamic information which may need to be activated
Step 9. Lower layers indicate to RRC that the processing of the lower layer signaling and/or the received dynamic information has been completed.
Step 10. RRC now continues with the RRC processing of the LTM cell switch procedure and may apply some more parameters which need to be configured only after the dynamic information has been applied.
Step 11. In this example, RRC submits, to the lower layers, e.g. the PDCP layer, an RRC message, such as RRCReconfigurationComplete, for transmission. In another example, RRC indicates to lower layers, such as the MAC layer, to transmit an indication that the LTM cell switch procedure has completed.
Steps 12-13. If needed, MAC triggers a random access procedure. In one example, the MAC layer does not trigger a random access procedure when it has a valid TA value for the candidate cell. In another example, the MAC layer triggers a random access procedure when it does not have a valid TA or when RRC indicates to MAC to trigger a random access procedure.
Step 14-15. In this example, lower layers initiate the transmission of the RRC message to the candidate DU on an uplink physical channel. The lower layers may trigger a scheduling request if there is no UL grant already received (from the target cell or in the lower layer signaling). In another example, lower layers transmit, to the candidate DU, an indication that the LTM cell switch procedure has completed.
Step 16. In this example, lower layers indicate, to RRC, that the RRC message has been transmitted or alternatively, that a random access procedure was performed. In another example, lower layers indicate, to RRC, that the indication to the network that the LTM cell switch procedure has completed has been transmitted.
Step 17. In this example, RRC stops the supervision timer (such as a T304 timer). The LTM cell switch procedure ends.

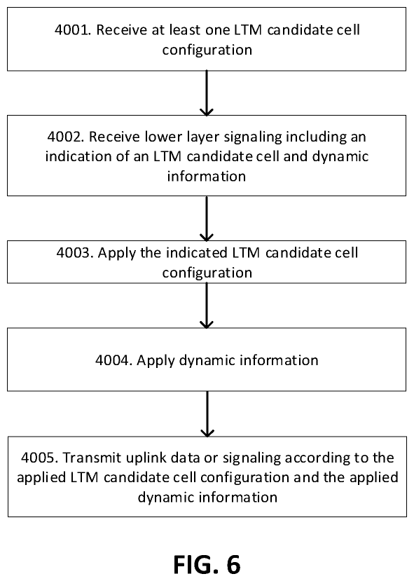

FIG. 6 illustrates a flow chart of a method according to examples of this disclosure, with the main steps performed by the UE in one example of this disclosure. Referring to FIG. 6, the main steps performed by the UE in this example are as follows.
Step 4001. the Ue Receives at Least One Ltm Candidate Cell Configuration From the Network.
Step 4002. The UE receives a lower layer signaling to trigger an LTM cell switch procedure. The lower layer signaling contains an indication of the LTM candidate cell configuration for the LTM candidate cell and dynamic information. In this example, the dynamic information is included in the same MAC CE as the indication of the LTM candidate cell configuration. In another example, the indication of the LTM candidate cell configuration is contained in one MAC CE and the dynamic information is contained in one or multiple other MAC CEs.
Step 4003. As response to the lower layer signaling, the UE executes the LTM cell switch procedure. The UE first applies the LTM candidate cell configuration.
Step 4004. After having applied the LTM candidate cell configuration, the UE applies the received dynamic information.
Step 4005. The UE now transmits uplink data or signalling to the Candidate DU, such as an RRCReconfigurationComplete message, after a potential random access procedure, according to the applied LTM candidate cell configuration and dynamic information

FIG. 7 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes Q110), or any other similar 3^{rd} Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network QQ102 includes one or more Open-RAN (ORAN) network nodes. An ORAN network node is a node in the telecommunication network QQ102 that supports an ORAN specification (e.g., a specification published by the O-RAN Alliance, or any similar organization) and may operate alone or together with other nodes to implement one or more functionalities of any node in the telecommunication network QQ102, including one or more network nodes QQ110 and/or core network nodes QQ108.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), Policy Control Function (PCF) and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more services. Examples of such applications include the provision of live and/or pre-recorded audio/video content, data collection services, for example, retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 7 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive Iot services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example illustrated in FIG. 7, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, a content source and analytics node, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular if one or more of the UEs are low energy Iot devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub-that is, a hub whose primary function is to route communications to/from the UEs from/to the network node QQ110b. In other embodiments, the hub QQ114 may be a non-dedicated hub-that is, a device which is capable of operating to route communications between the UEs and network node QQ110b, but which is additionally capable of operating as a communication start and/or end point for certain data channels.

FIG. 8 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless camera, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IOT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V21), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 8. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs). The processing circuitry QQ202 may be operable to provide, either alone or in conjunction with other UE QQ200 components, such as the memory QQ210, UE QQ200 functionality. For example, the processing circuitry QQ202 may be configured to cause the UE QQ202 to perform the methods as described with reference to FIG. 1.

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In some embodiments, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or controls a robotic arm performing a medical procedure according to the received input.

A UE, when in the form of an Internet of Things (Iot) device, may be a device for use in one or more application domains, these domains comprising, but not limited to, city wearable technology, extended industrial application and healthcare. Non-limiting examples of such an IoT device are devices which are or which are embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an Iot device comprises circuitry and/or software in dependence on the intended application of the Iot device in addition to other components as described in relation to the UE QQ200 shown in FIG. 8.

As yet another specific example, in an Iot scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IOT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 9 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs), and/or Minimization of Drive Tests (MDTs).

The network node QQ300 includes processing circuitry QQ302, a memory QQ304, a communication interface QQ306, and a power source QQ308, and/or any other component, or any combination thereof. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, network node QQ300 functionality. For example, the processing circuitry QQ302 may be configured to cause the network node to perform the methods as described with reference to FIG. 2.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 9 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

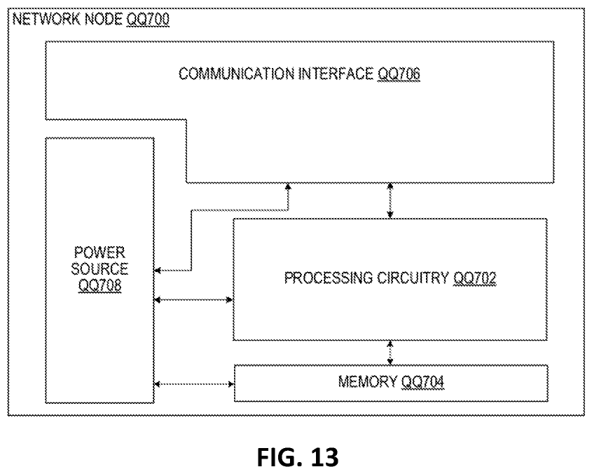

FIG. 13 shows a network node QQ700 in accordance with some embodiments. As used herein, network node refers to equipment capable, configured, arranged and/or operable to communicate directly or indirectly with a UE and/or with other network nodes or equipment, in a telecommunication network. The network node QQ700 may be operable as a core network node, a core network function or, more generally, a core network entity, such as the core network node QQ108 described above with respect to FIG. 7). Examples of network nodes in this context include core network entities such as one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), Policy Control Function (PCF) and/or a User Plane Function (UPF).

The network node QQ700 includes processing circuitry QQ702, a memory QQ704, a communication interface QQ706, and a power source QQ708, and/or any other component, or any combination thereof. The network node QQ700 may be composed of multiple physically separate components, which may each have their own respective components. In certain scenarios in which the network node QQ700 comprises multiple separate components, one or more of the separate components may be shared among several network nodes.

The processing circuitry QQ702 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ700 components, such as the memory QQ704, network node QQ700 functionality.

The memory QQ704 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ702. The memory QQ704 may store any suitable instructions, data, or information, including a computer program, software, an application including one or more of logic, rules, code, tables, and/or other instructions capable of being executed by the processing circuitry QQ702 and utilized by the network node QQ700. The memory QQ704 may be used to store any calculations made by the processing circuitry QQ702 and/or any data received via the communication interface QQ706. In some embodiments, the processing circuitry QQ702 and memory QQ704 is integrated.

The communication interface QQ706 is used in wired or wireless communication of signaling and/or data between a network node, access network, and/or UE.

The power source QQ708 provides power to the various components of network node QQ700 in a form suitable for the respective components (e.g., at a voltage and current level needed for each respective component). The power source QQ708 may further comprise, or be coupled to, power management circuitry to supply the components of the network node QQ700 with power for performing the functionality described herein. For example, the network node QQ700 may be connectable to an external power source (e.g., the power grid, an electricity outlet) via an input circuitry or interface such as an electrical cable, whereby the external power source supplies power to power circuitry of the power source QQ708. As a further example, the power source QQ708 may comprise a source of power in the form of a battery or battery pack which is connected to, or integrated in, power circuitry. The battery may provide backup power should the external power source fail.

Embodiments of the network node QQ700 may include additional components beyond those shown in FIG. 13 for providing certain aspects of the network node's functionality, including any of the functionality described herein and/or any functionality necessary to support the subject matter described herein. For example, the network node QQ700 may include user interface equipment to allow input of information into the network node QQ700 and to allow output of information from the network node QQ700. This may allow a user to perform diagnostic, maintenance, repair, and other administrative functions for the network node QQ700.

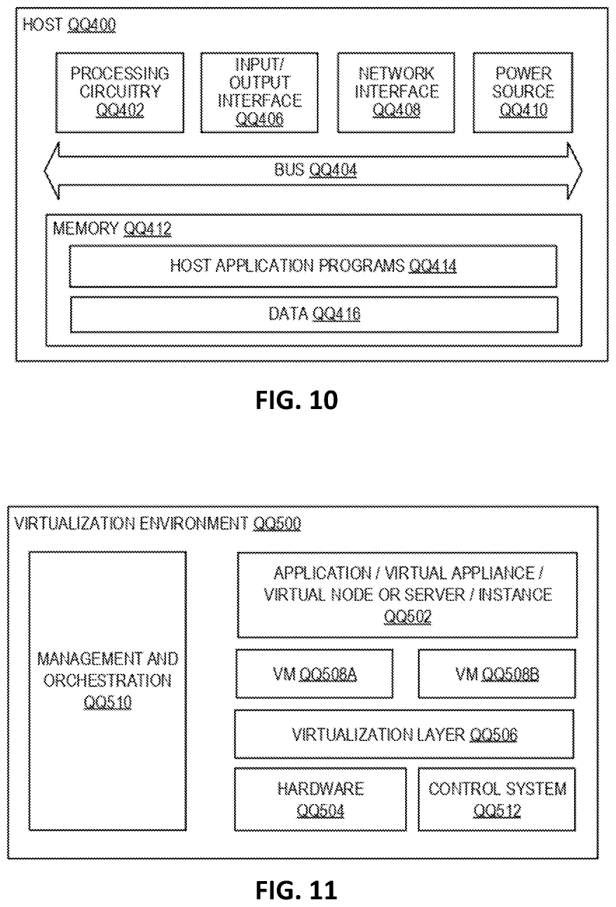

FIG. 10 is a block diagram of a host QQ400, which may be an embodiment of the host QQ116 of FIG. 7, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as FIGS. 8 and 9, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (WVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 11 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment QQ500 includes components defined by the O-RAN Alliance, such as an O-Cloud environment orchestrated by a Service Management and Orchestration Framework via an O-2 interface.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization.

Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

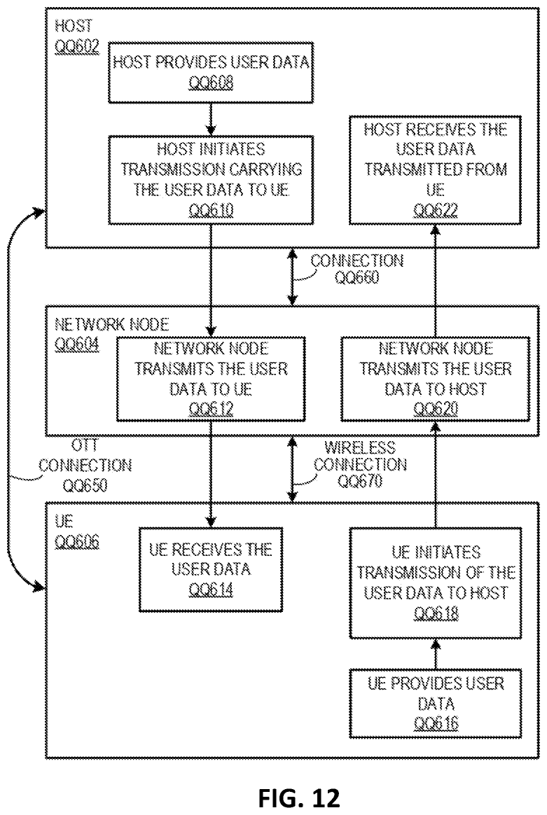

FIG. 12 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 7 and/or UE QQ200 of FIG. 8), network node (such as network node QQ110a of FIG. 7 and/or network node QQ300 of FIG. 9), and host (such as host QQ116 of FIG. 7 and/or host QQ400 of FIG. 10) discussed in the preceding paragraphs will now be described with reference to FIG. 12.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 7) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, the teachings of these embodiments may provide benefits such as ensuring that dynamic information is applied on the configuration the UE uses in the target cell, and not in the source cell.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc. ; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602.

The measurements may be implemented in that software causes messages to be transmitted, in particular empty or ‘dummy’ messages, using the OTT connection QQ650 while monitoring propagation times, errors, etc.

This disclosure includes the following enumerated embodiments.

### EMBODIMENTS

### Group A Embodiments

1. A method performed by a User Equipment (UE) for performing a cell switch procedure, the method comprising:
receiving one or more candidate target cell configurations;
receiving one or more messages associated with a layer lower than a Radio Resource Control (RRC) layer or lower than a Layer 3 (L3) layer, wherein the one or more messages identify one of the one or more candidate target cell configurations and include one or more parameters for the UE; and
applying the identified candidate target cell configuration and applying the one or more parameters.

2. The method of embodiment 1, wherein the cell switch procedure comprises a L1/L2-triggered mobility (LTM) cell switch procedure.

3. The method of embodiment 1 or 2, wherein the one or more candidate target cell configurations comprise one or more LTM candidate cell configurations.

4. The method of any of embodiments 1 to 3, wherein performing the cell switch procedure comprises applying the identified candidate target cell configuration.

5. The method of any of embodiments 1 to 4, wherein applying the identified candidate target cell configuration comprises executing the identified candidate target cell configuration.

6. The method of any of embodiments 1 to 4, wherein applying the one or more parameters is performed after applying the identified candidate target cell configuration, or applying the one or more parameters is performed before applying the identified candidate target cell configuration.

7. The method of any of embodiments 1 to 5, wherein the one or more messages include a command to perform the cell switch procedure.

8. The method of any of embodiments 1 to 6, wherein the layer lower than the RRC layer or lower than the L3 layer comprises a MAC layer, a PDCP layer. a RLC layer, a physical layer, a data link layer, a Layer 1 (L1) layer, or a Layer 2 (L2) layer.

9. The method of any of embodiments 1 to 7, wherein applying the identified candidate target cell configuration is performed by the RRC layer.

10. The method of embodiment 8, wherein the RRC layer applies the identified candidate target cell configuration in response to an indication from the layer lower than the RRC layer or lower than the L3 layer.

11. The method of embodiment 10, wherein the indication from the layer lower than the RRC layer or lower than the L3 layer is received after receiving the identification of the identified candidate target cell configuration.

12. The method of embodiment 10 or 11, wherein the indication from the layer lower than the RRC layer or lower than the L3 layer identifies the identified candidate target cell configuration.

13. The method of any of embodiments 9 to 12, wherein the RRC layer sends an indication to the layer lower than the RRC layer or lower than the L3 layer after applying the identified candidate target cell configuration.

14. The method of any of embodiments 1 to 13, wherein applying the one or more parameters is performed by the layer lower than the RRC layer or lower than the L3 layer, or layer lower than the layer lower than the RRC layer or lower than the layer lower than the L3 layer.

15. The method of embodiment 14, wherein applying the one or more parameters is performed by a physical layer or a L1 layer.

16. The method of embodiment 15, wherein the physical layer or the L1 layer applies the one or more parameters in response to receiving an indication from the RRC layer or a MAC layer.

17. The method of embodiment 16, wherein the indication from the RRC layer or the MAC layer indicates that the identified candidate target cell configuration has been applied.

18. The method of embodiment 15, wherein the physical layer or the L1 layer applies the one or more parameters in response to receiving the one or more parameters.

19. The method of embodiment 14, wherein applying the one or more parameters is performed by a MAC layer or L2 layer.

20. The method of embodiment 19, wherein the MAC layer or the L2 layer applies the one or more parameters in response to receiving an indication from the RRC layer.

21. The method of embodiment 20, wherein the indication from the RRC layer indicates that the identified candidate target cell configuration has been applied.

22. The method of embodiment 19, wherein the MAC layer or the L2 layer applies the one or more parameters in response to receiving the one or more parameters.

23. The method of any of embodiments 1 to 22, wherein the one or more messages comprise one or more MAC control elements (MAC CEs).

24. The method of embodiment 23, wherein the one or more parameters and the identification of identified candidate target cell configuration are received in the same MAC CE.

25. The method of embodiment 23, wherein the identification of the identified candidate target cell configuration is received in one or more first MAC CEs, and the one or more parameters are received in one or more second MAC CEs.

26. The method of embodiment 24 or 25, wherein applying the one or more parameters is performed in response to receiving an indication in the one or more messages identifying the same MAC CE or the one or more second MAC CEs.

27. The method of embodiment 26, wherein the indication in the one or more messages is received with the identification of the identified candidate target cell configuration.

28. The method of any of embodiments 1 to 27, wherein the one or more parameters and the identification of identified candidate target cell configuration are received in a same MAC PDU.

29. The method of any of embodiments 1 to 28, wherein the one or more messages includes an indication that the one or more messages includes the one or more parameters.

30. The method of embodiment 29, wherein the indication that the one or more messages includes the one or more parameters is received with the identification of the identified candidate target cell configuration.

31. the Method of Any of Embodiments 1 to 30, Wherein the One or More Parameters comprise one or more of:
a Beam indication;
SCell activation/deactivation indication(s) for one or more SCells of the UE;
CSI measurement configuration activation/deactivation indication(s) for one or more CSI measurement configurations of the UE;
TCI state(s) indication(s);
Spatial relation indication;
RS indication;
UL grant;
PUCCH configuration;
SCG state;
PRACH configuration to be used by the UE;
DL BWP ID;
UL BWP ID;
C-RNTI out of a set;
Timer value for the cell switch procedure; and/or
Timing advance command for the UE.

32. The method of any of 1 to 31, wherein the identified candidate target cell configuration or each of the one or more candidate target cell configurations comprises one or more of:
A cell group configuration for a Master Cell Group (MCG) or a Secondary Cell Group (SCG);
A serving cell configuration for a SpCell, PCell, PSCell or SCell;
A bandwidth Part (BWP) configuration;
An RRCReconfiguration message;
A measurement configuration;
A radio bearer configuration;
AUE identity or C-RNTI;
System information;
A timer configuration;
Another candidate cell configuration;
An indication for the UE to perform a full configuration;
An indication for the UE to perform a delta configuration;
A reference configuration; and/or
Indication(s) whether or not to perform L2 reset, MAC reset, partial MAC reset, full MAC reset, RLC re-establishment and/or PDCP recovery or re-establishment.

33. the Method of Any of Embodiments 1 to 32, Comprising Starting a Timer in Response to:
receiving the one or more messages;
receiving the identification of the one of the one or more candidate target cell configurations;
receiving the one or more parameters for the UE;
applying the identified candidate target cell configuration;
applying the one or more parameters; and/or
receiving or performing a command to perform the cell switch procedure.

34. The method of embodiment 33, comprising stopping the timer in response to:
successfully or unsuccessfully performing the cell switch procedure;
successfully or unsuccessfully applying the identified candidate cell configuration;
successfully or unsuccessfully performing a random access procedure after applying the identified candidate cell configuration;
successful or unsuccessful transmission of uplink data or signaling after applying the identified candidate cell configuration;
submission of uplink data or signaling to the layer lower than the RRC layer or lower than the L3 layer after applying the identified candidate cell configuration; and/or
reception the RRC layer or the L3 layer of uplink data or signalling to be transmitted after applying the identified candidate cell configuration.

35. The method of any of embodiments 1 to 34, comprising performing an L2 reset, MAC reset, partial MAC reset, full MAC reset, RLC re-establishment and/or PDCP recovery or re-establishment.

36. The method of embodiment 35, wherein the L2 reset, MAC reset, partial MAC reset, full MAC reset, RLC re-establishment and/or PDCP recovery or re-establishment is performed after or as part of applying the identified candidate cell configuration.

37. The method of embodiment 35 or 36, comprising performing the L2 reset, MAC reset, partial MAC reset, full MAC reset, RLC re-establishment and/or PDCP recovery or re-establishment after applying the one or more parameters.

38. The method of any of embodiments 35 to 37, wherein the L2 reset, MAC reset, partial MAC reset, full MAC reset, RLC re-establishment and/or PDCP recovery or re-establishment is performed in response to an indication from the RRC layer or the L3 layer.

39. The method of any of embodiments 1 to 38, wherein the one or more candidate target cell configurations and/or the one or more messages are received from a network node.

40. The method of embodiment 39, wherein the network node comprises a gNB, Distributed Unit (DU) or Central Unit (CU).

41. The method of any of the previous embodiments, further comprising: providing user data; and forwarding the user data to a host via the transmission to the network node.

### Group B Embodiments

42. A method performed by a network node for causing a User Equipment (UE) to perform a cell switch procedure, the method comprising:
sending, to the UE, one or more candidate target cell configurations;
sending, to the UE, one or more messages associated with a layer lower than a Radio Resource Control (RRC) layer or lower than a Layer 3 (L3) layer, wherein the one or more messages identify one of the one or more candidate target cell configurations and include one or more parameters to be applied by the UE.

43. The method of embodiment 42, wherein the cell switch procedure comprises a L1/L2-triggered mobility (LTM) cell switch procedure.

44. The method of embodiment 42 or 43, wherein the one or more candidate target cell configurations comprise one or more LTM candidate cell configurations.

45. The method of any of embodiments 42 to 44, wherein the one or more messages include a command to perform the cell switch procedure.

46. The method of any of embodiments 42 to 45, wherein the layer lower than the RRC layer or lower than the L3 layer comprises a MAC layer, a PDCP layer. a RLC layer, a physical layer, a data link layer, a Layer 1 (L1) layer, or a Layer 2 (L2) layer.

47. The method of any of embodiments 42 to 46, wherein the one or more messages comprise one or more MAC control elements (MAC CEs).

48. The method of embodiment 47, wherein the one or more parameters and the identification of identified candidate target cell configuration are sent in the same MAC CE.

49. The method of embodiment 47, wherein the identification of the identified candidate target cell configuration is sent in one or more first MAC CEs, and the one or more parameters are sent in one or more second MAC CEs.

50. The method of embodiment 24 or 25, the one or more messages includes an indication identifying the same MAC CE or the one or more second MAC CEs.

51. The method of embodiment 50, wherein the indication in the one or more messages is sent with the identification of the identified candidate target cell configuration.

52. The method of any of embodiments 42 to 51, wherein the one or more parameters and the identification of identified candidate target cell configuration are sent in a same MAC PDU.

53. The method of any of embodiments 42 to 52, wherein the one or more messages includes an indication that the one or more messages includes the one or more parameters.

54. The method of embodiment 29, wherein the indication that the one or more messages includes the one or more parameters is sent with the identification of the identified candidate target cell configuration.

55. The method of any of embodiments 42 to 54, wherein the one or more parameters comprise one or more of:
a Beam indication;
SCell activation/deactivation indication(s) for one or more SCells of the UE;
CSI measurement configuration activation/deactivation indication(s) for one or more CSI measurement configurations of the UE;
TCI state(s) indication(s);
Spatial relation indication;
RS indication;
UL grant;
PUCCH configuration;
SCG state;
PRACH configuration to be used by the UE;
DL BWP ID;
UL BWP ID;
C-RNTI out of a set;
Timer value for the cell switch procedure; and/or
Timing advance command for the UE.

56. The method of any of 42 to 55, wherein the identified candidate target cell configuration or each of the one or more candidate target cell configurations comprises one or more of:
A cell group configuration for a Master Cell Group (MCG) or a Secondary Cell Group (SCG);
A serving cell configuration for a SpCell, PCell, PSCell or SCell;
A bandwidth Part (BWP) configuration;
An RRCReconfiguration message;
A measurement configuration;
A radio bearer configuration;
A UE identity or C-RNTI;
System information;
A timer configuration;
Another candidate cell configuration;
An indication for the UE to perform a full configuration;
An indication for the UE to perform a delta configuration;
A reference configuration; and/or
Indication(s) whether or not to perform L2 reset, MAC reset, partial MAC reset, full MAC reset, RLC re-establishment and/or PDCP recovery or re-establishment.

57. The method of embodiment 39, wherein the network node comprises a gNB, Distributed Unit (DU) or Central Unit (CU).

58. The method of any of the previous embodiments, further comprising: obtaining user data; and
forwarding the user data to a host or a user equipment.

### Group D Embodiments

59. A user equipment for performing a cell switch procedure, comprising: processing circuitry configured to cause the user equipment to perform any of the steps of any of the Group A embodiments; and power supply circuitry configured to supply power to the processing circuitry.

60. A network node for causing a User Equipment (UE) to perform a cell switch procedure, the network node comprising: processing circuitry configured to cause the network node to perform any of the steps of any of the Group B embodiments; power supply circuitry configured to supply power to the processing circuitry.

61. A user equipment (UE) for performing a cell switch procedure, the UE comprising: an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output
information from the UE that has been processed by the processing circuitry; and
a battery connected to the processing circuitry and configured to supply power to the UE.

62. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

63. The host of the previous embodiment, wherein:
the processing circuitry of the host is configured to execute a host application that provides the user data; and
the UE comprises processing circuitry configured to execute a client application associated with the host application to receive the transmission of user data from the host.

64. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs any of the operations of any of the Group B embodiments to transmit the user data from the host to the UE.

65. The method of the previous embodiment, further comprising, at the network node, transmitting the user data provided by the host for the UE.

66. The method of any of the previous 2 embodiments, wherein the user data is provided at the host by executing a host application that interacts with a client application executing on the UE, the client application being associated with the host application.

67. A communication system configured to provide an over-the-top (OTT) service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication
interface and processing circuitry, the processing circuitry of the network node configured to perform any of the operations of any of the Group B embodiments to transmit the user data from the host to the UE.

68. The communication system of the previous embodiment, further comprising: the network node; and/or
the UE.

69. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

70. The host of the previous 2 embodiments, wherein:
the processing circuitry of the host is configured to execute a host application that receives the user data; and
the host application is configured to interact with a client application executing on the UE, the client application being associated with the host application.

71. The host of the any of the previous 2 embodiments, wherein the initiating receipt of the user data comprises requesting the user data.

72. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs any of the steps of any of the Group B embodiments to receive the user data from the UE for the host.

73. The method of the previous embodiment, further comprising at the network node, transmitting the received user data to the host.

74. A host configured to operate in a communication system to provide an over-the-top (OTT) service, the host comprising:
processing circuitry configured to provide user data; and
a network interface configured to initiate transmission of the user data to a cellular network for transmission to a user equipment (UE), wherein the UE comprises a communication interface and processing circuitry, the communication interface and processing circuitry of the UE being configured to perform any of the operations of any of the Group A embodiments to receive the user data from the host.

75. The host of the previous embodiment, wherein the cellular network further includes a network node configured to communicate with the UE to transmit the user data to the UE from the host.

76. the Host of the Previous 2 Embodiments, Wherein:
the processing circuitry of the host is configured to execute a host application, thereby providing the user data; and
the host application is configured to interact with a client application executing on the UE, the client application being associated with the host application.

77. A method implemented by a host operating in a communication system that further includes a network node and a user equipment (UE), the method comprising:
providing user data for the UE; and
initiating a transmission carrying the user data to the UE via a cellular network comprising the network node, wherein the UE performs any of the operations of any of the Group A embodiments to receive the user data from the host.

78. The method of the previous embodiment, further comprising:
at the host, executing a host application associated with a client application executing on the UE to receive the user data from the host application.

79. The method of the previous embodiment, further comprising:
at the host, transmitting input data to the client application executing on the UE, the input data being provided by executing the host application,
wherein the user data is provided by the client application in response to the input data from the host application.

80. A host configured to operate in a communication system to provide an over-the-top (OTT) service, the host comprising:
processing circuitry configured to provide user data; and
a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.

81. The host of the previous embodiment, wherein the cellular network further includes a network node configured to communicate with the UE to transmit the user data from the UE to the host.

82. The host of the previous 2 embodiments, wherein:
the processing circuitry of the host is configured to execute a host application, thereby providing the user data; and
the host application is configured to interact with a client application executing on the UE, the client application being associated with the host application.

83. A method implemented by a host configured to operate in a communication system that further includes a network node and a user equipment (UE), the method comprising: at the host, receiving user data transmitted to the host via the network node by the UE, wherein the UE performs any of the steps of any of the Group A embodiments to transmit the user data to the host.

84. The method of the previous embodiment, further comprising:
at the host, executing a host application associated with a client application executing on the UE to receive the user data from the UE.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1-39. (canceled)

40. A method performed by a User Equipment (UE) for performing a Layer 1/Layer 2-triggered mobility (LTM) cell switch procedure, the method comprising:
receiving one or more LTM candidate cell configurations;
receiving, from a network node, a message associated with a layer lower than a Radio Resource Control (RRC) layer, the message comprising a Medium Access Control (MAC) control element (CE) being an LTM cell switch command, wherein the message identifies one of the one or more LTM candidate cell configurations and includes one or more parameters for the UE, wherein the one or more parameters comprise a Timing Advance command for the UE and a TCI state indication, and wherein the one or more parameters and the identification of the identified LTM candidate cell configuration are received in the MAC CE;
in response to receiving the message, applying the identified LTM candidate cell configuration; and
in response to applying the identified LTM candidate cell configuration, applying the one or more parameters.

41. The method of claim 40, wherein performing the cell switch procedure comprises applying the identified LTM candidate cell configuration.

42. The method of claim 40, wherein applying the one or more parameters is performed after applying the identified LTM candidate cell configuration.

43. The method of claim 40, wherein the layer lower than the RRC layer comprises a MAC layer, a Packet Data Convergence Protocol (PDCP) layer, a Radio Link Control (RLC) layer, a physical layer, a data link layer, a Layer 1 (L1) layer, or a Layer 2 (L2) layer.

44. The method of claim 40, wherein applying the identified LTM candidate cell configuration is performed by the RRC layer.

45. The method of claim wherein the RRC layer applies the identified LTM candidate cell configuration in response to an indication from the layer lower than the RRC layer.

46. The method of claim 45, wherein the indication from the layer lower than the RRC layer is received after receiving the identification of the identified LTM candidate cell configuration, and/or identifies the identified LTM candidate cell configuration.

47. The method of claim 44, wherein the RRC layer sends an indication to the layer lower than the RRC layer after applying the identified LTM candidate cell configuration.

48. The method of claim 40, wherein applying the one or more parameters is performed by the layer lower than the RRC layer.

49. The method of claim 48, wherein applying the one or more parameters is performed by a physical layer or a Layer 1 (L1) layer.

50. The method of claim 49, wherein the physical layer or the LI layer applies the one or more parameters in response to receiving an indication from the RRC layer or a MAC layer, wherein the indication from the RRC layer or the MAC layer indicates that the identified LTM candidate cell configuration has been applied, or the physical layer or the L1 layer applies the one or more parameters in response to receiving the one or more parameters.

51. The method of claim 48, wherein applying the one or more parameters is performed by a MAC layer or a Layer 2 (L2) layer.

52. The method of claim 51, wherein the MAC layer or the L2 layer applies the one or more parameters in response to receiving an indication from the RRC layer, wherein the indication from the RRC layer indicates that the identified LTM candidate cell configuration has been applied, or the MAC layer or the L2 layer applies the one or more parameters in response to receiving the one or more parameters.

53. The method of claim 40, wherein the identified LTM candidate cell configuration or each of the one or more LTM candidate cell configurations comprises one or more of:
a cell group configuration for a Master Cell Group (MCG) or a Secondary Cell Group (SCG);
a serving cell configuration for a Special Cell (SpCell), a Primary Cell (PCell), a Primary Secondary Cell (PSCell), or a Secondary Cell (SCell);
a bandwidth Part (BWP) configuration;
an RRC Reconfiguration message;
a measurement configuration;
a radio bearer configuration;
a UE identity or Cell Radio Network Temporary Identifier (C-RNTI);
system information;
a timer configuration;
another candidate cell configuration;
an indication for the UE to perform a full configuration;
an indication for the UE to perform a delta configuration;
a reference configuration; and/or
one or more indications of whether or not to perform L2 reset, MAC reset, partial MAC reset, full MAC reset, RLC re-establishment, and/or Packet Data Convergence Protocol (PDCP) recovery or re-establishment.

54. The method of claim 40, further comprising:
starting a timer in response to applying the identified LTM candidate cell configuration; and
stopping the timer in response to:
successfully performing the LTM cell switch procedure;
successfully applying the identified LTM candidate cell configuration;
successfully performing a random access procedure after applying the identified LTM candidate cell configuration;
successful transmission of uplink data or signaling after applying the identified LTM candidate cell configuration;
submission of uplink data or signaling to the layer lower than the RRC layer after applying the identified LTM candidate cell configuration; and/or
reception at the RRC layer of uplink data or signaling to be transmitted after applying the identified LTM candidate cell configuration.

55. The method of claim 40, comprising performing MAC reset after or as part of applying the identified LTM candidate cell configuration and/or in response to an indication from the RRC layer.

56. The method of claim 40, wherein the network node comprises a gNB, a Distributed Unit (DU), or a Central Unit (CU).

57. An apparatus in a User Equipment (UE) for performing a Layer 1/Layer 2-triggered mobility (LTM) cell switch procedure, the apparatus comprising a processor and a memory, the memory containing instructions executable by the processor whereby the apparatus is operable to:
receive one or more LTM candidate cell configurations;
receive, from a network node, a message associated with a layer lower than a Radio Resource Control (RRC) layer, the message comprising a MAC CE being an LTM cell switch command, wherein the message identifies one of the one or more LTM candidate cell configurations and includes one or more parameters for the UE, wherein the one or more parameters comprise a Timing advance command for the UE and a TCI state indication, and wherein the one or more parameters and the identification of the identified LTM candidate cell configuration are received in the MAC CE;
in response to receiving the message, apply the identified LTM candidate cell configuration; and
in response to applying the identified LTM candidate cell configuration, apply the one or more parameters.
